(19) United States
(12) Patent Application Publication
(10) Pub. No.: US 2015/0106723 A1
(43) Pub. Date: Apr. 16, 2015

(54) TOOLS FOR LOCATING, CURATING, EDITING, AND USING CONTENT OF AN ONLINE LIBRARY

(71) Applicant: JONES INTERNATIONAL, LTD., CENTENNIAL, CO (US)

(72) Inventor: JAMES BERTELSEN, CENTENNIAL, CO (US)

(73) Assignee: JONES INTERNATIONAL, LTD., CENTENNIAL, CO (US)

(21) Appl. No.: 14/254,024

(22) Filed: Apr. 16, 2014

Related U.S. Application Data
(60) Provisional application No. 61/889,073, filed on Oct. 10, 2013.

(51) Int. Cl. G06F 3/0484; G06F 17/30

(52) U.S. Cl. CPC G06F 3/04842; G06F 17/30861
USPC 715/738

(57) ABSTRACT

Embodiments can comprise a tool which provides access to an online library and a number of supporting functions including but not limited to functions for searching for content, capturing found content into the library, editing the captured content, and tracking use of the content. In one embodiment, this tool can be implemented as an extension to a client-side application such as a web browser. In such an implementation, the tool may be accessible through an icon on the toolbar of the browser. Launching of this tool, for example by a selection of the icon from the toolbar of the browser, can initiate or provide access to the functions and features described herein.

### CROSS-REFERENCES TO RELATED APPLICATIONS

The present application claims benefit under 35 USC 119(e) of U.S. Provisional Application No. 61/889,073, filed on Oct. 10, 2013 by Bertelsen and entitled “Tools for Locating, Curating, Editing, and Using Content of an Online Library; Conducting Automated Exhaustive Searches; and Maintaining Credentials,” of which the entire disclosure is incorporated herein by reference for all purposes.

### BACKGROUND OF THE INVENTION

Embodiments of the present invention relate generally to methods and systems for locating and accessing online content and more particularly to improved user interfaces and supporting methods and systems for locating and accessing content available in an online library or elsewhere online.

Online content, i.e., content available to a user over the Internet or other network, can be stored and available through a variety of methods and different locations. In some cases, information may be organized into, stored in, and/or available through an online library or similar repository. Generally speaking, an online library can be considered a collection of content or references, e.g., links, to content of interest to a particular user or group of users. The content of such a library is typically accessible by the users through a browser or other client-side application executing on the user's computer or other device.

In order to locate, access, and use this online content, a user typically points the browser to a known location or Universal Resource Locator (URL) for that online content. If the URL is not known or the user does not have a specific piece of online content in mind, that user may use a search engine to locate online content related to a set of search terms indicating the concepts the user is interested in. Currently, this requires the user to navigate to a page for that search engine. So, when a user is viewing online content but wishes to locate additional online content, that user is required to at least temporarily navigate away from viewing the initial online content. As a result, the user may end up navigating back and forth between pages or may keep multiple browser instances/pages open at a particular time. This is not an efficient or effective way to navigate online content, especially as the volume of available online content grows. Additionally, the located online content is generally not readily available or easily accessible at a later time when the user may want to return to the online content or search it along with other previously obtained search results. The located online content is also not readily usable for purposes of online teaching and does not support tracking the users' activities to discern if the course or learning project is being accomplished accurately. Hence, there is a need for improved methods and systems for locating, accessing, using, curating, tracking, storing, retrieving, and identifying learning activities using online content for courses or learning projects.

### BRIEF SUMMARY OF THE INVENTION

Embodiments of the invention provide systems and methods for improved user interfaces and supporting methods and systems for locating, curating, editing, and using content such that it is available in an online library or elsewhere online. According to one embodiment, a method for locating and interacting content of an online library can comprise executing an application providing a view of content of the online library. The application can further provide access to a tool providing a plurality of functions supported by the online library for locating and interacting with the content of the online library. An indication of a user request to access the tool can be received through the application and, in response to the indication, the tool can be launched through the application. Launching the tool can comprise providing a graphical dialog including a first plurality of graphical elements representing each of a plurality of features provided by the tool. For example, the plurality of features provided by the tool can include at least a search feature and a browse feature through which content can be located.

According to one embodiment, locating content through the browse feature can comprise receiving through the graphical dialog an indication of a user selection of one of the first plurality of graphical elements representing the browse feature provided by the tool and in response to the indication, updating the graphical dialog to a list including a list identifying and providing access to the content of the online library. Locating content through the search feature can comprise receiving through the graphical dialog an indication of a user selection of one of the first plurality of graphical elements representing the search feature provided by the tool and in response to the indication, updating the graphical dialog to further include a second plurality of graphical elements representing each of a plurality of search functions provided by the tool.

The plurality of search functions can include a current searches function providing access to one or more searches and corresponding results. In such cases, providing access to one or more searches and corresponding results can comprise receiving through the graphical dialog an indication of a user selection of the graphical indication of the current searches function and in response to the indication, updating the graphical dialog to further include a third plurality of graphical elements representing each of one or more current searches, each of the third plurality of graphical elements including an identification of the represented current search. An indication of a user selection of one of the third plurality of graphical elements can be received through the graphical dialog and in response to the indication, the graphical dialog can be updated to further include results for the search corresponding to the selected one of the third plurality of graphical elements.

For example, the selected one of the third plurality of graphical elements can include a graphical indication of a filter function of the tool and searching can further include receiving through the graphical dialog an indication of a user selection of the graphical indication of the filter function. In response to the indication, the graphical dialog can be updated to further include one or more elements for defining filter conditions. Filter conditions can be received through the one or more elements for defining the filter conditions and based on the received filter conditions, the results for the search can be updated corresponding to the selected one of the third plurality of graphical elements.

According to one embodiment, the plurality of search functions can include a favorite searches function providing access to one or more prior searches saved by the tool in response to a request from the user. In such cases, an indication of a user selection of one of the second plurality of graphical elements representing the favorite searches function can be received through the graphical dialog. In response to the indication, the graphical dialog can be updated to further include a list identifying and providing access to each of the one or more prior searches.

Additionally or alternatively, the plurality of search functions can include a search history function providing access to one or more prior searches saved by the tool automatically. In such cases, an indication of a user selection of one of the second plurality of graphical elements representing the search history function can be received through the graphical dialog. In response to the indication, the graphical dialog can be updated to further include a list including a list identifying and providing access to each of the one or more prior searches.

The plurality of features provided by the tool can additionally or alternatively comprise a content capture feature. In such cases, the content located using the search feature can be captured through the content capture feature of the tool upon a selection of the content capture feature. Capturing the located content through the content capture feature of the tool can comprise receiving through the graphical dialog an indication of a user selection of one of the first plurality of graphical elements representing the content capture feature provided by the tool, capturing currently viewed content automatically and in response to receiving the user selection, and launching a content capture dialog. The content capture dialog can comprise a plurality of graphical elements representing information from the captured currently viewed content. The content capture dialog can be presented including the plurality of graphical elements representing information from the captured currently viewed content within the graphical dialog. An indication of a user selection of a location for saving the captured currently viewed content can be received through the content capture dialog and the captured currently viewed content can be at the location indicated by the user selection.

Additionally or alternatively, the plurality of features provided by the tool can comprise a content edit feature and the captured content can be edited through one or more functions of the content edit feature upon a selection of the content edit feature. Editing the captured content through one or more functions of the content edit feature can comprise receiving through the graphical dialog an indication of a user selection of one of the first plurality of graphical elements representing the content edit feature provided by the tool, presenting a content edit toolbar comprising a plurality of graphical elements, each of the plurality of graphical elements representing a function of the content edit feature, and receiving through the content edit toolbar an indication of a user selection of one or more of the graphical elements representing the functions of the content edit feature.

For example, the one or more functions of the content edit feature can comprise a highlighter function. In such cases, editing the captured content can comprise launching the highlighter function in response to receiving through the content edit toolbar an indication of a user selection of the graphical element of the content edit toolbar representing the highlighter function, receiving a user selection of at least a portion of a currently viewed content, and marking the portion of the currently viewed content selected by the user as highlighted.

In another example, the one or more functions of the content edit feature can comprise a note function. In such cases, editing the captured content can comprise launching the note function in response to receiving through the content edit toolbar an indication of a user selection of the graphical element of the content edit toolbar representing the note function, wherein launching the note function comprises presenting a graphical note element related to a currently viewed content, receiving user defined text or other content directed to the currently viewed content, and adding the received user defined text or other content to the graphical note element.

In yet another example, the one or more functions of the content edit feature comprise a content embedding function. In such cases, editing the captured content can comprise launching the content embedding function in response to receiving through the content edit toolbar an indication of a user selection of the graphical element of the content edit toolbar representing the content embedding function, wherein launching the content embedding function comprises presenting a graphical dialog element related to a currently viewed content, receiving a user selection of a resource related to the currently viewed content, and adding the user selected resource to the graphical dialog element.

### BRIEF DESCRIPTION OF THE DRAWINGS

FIG. 1 is a block diagram illustrating components of an exemplary distributed system in which various embodiments of the present invention may be implemented.

FIG. 2 is a block diagram illustrating components of a system environment by which services provided by embodiments of the present invention may be offered as cloud services.

FIG. 3 is a block diagram illustrating an exemplary computer system in which embodiments of the present invention may be implemented.

FIG. 4 is a block diagram illustrating, at a high-level, functional components of a system for locating, curating, editing, and using content of an online library according to one embodiment of the present invention.

FIGS. 5-8 are a set of screenshots illustrating exemplary user interfaces in which a tool for locating and accessing content of an online library may be implemented according to various embodiments of the present invention.

FIG. 9 is a flowchart illustrating a process for locating and accessing content of an online library according to one embodiment of the present invention.

FIGS. 10-12 are a set of screenshots illustrating exemplary user interfaces in which a tool for capturing content of an online library may be implemented according to various embodiments of the present invention.

FIG. 13 is a flowchart illustrating a process for capturing content of an online library according to one embodiment of the present invention.

FIGS. 14-19 are a set of screenshots illustrating exemplary user interfaces in which a tool for editing content of an online library may be implemented according to various embodiments of the present invention.

FIG. 20 is a flowchart illustrating a process for editing content of an online library according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments can comprise a tool which provides access to an online library and a number of supporting functions including but not limited to functions for searching for content, capturing found content into the library, editing the captured content, and tracking use of the content. In one embodiment, this tool can be implemented as an extension to a client-side application such as a web browser. In such an implementation, the tool may be accessible through an icon on the toolbar of the browser. Launching of this tool, for example by a selection of the icon from the toolbar of the browser, can initiate or provide access to the functions and features described herein. Various additional details of embodiments of the present invention will be described below with reference to the figures.

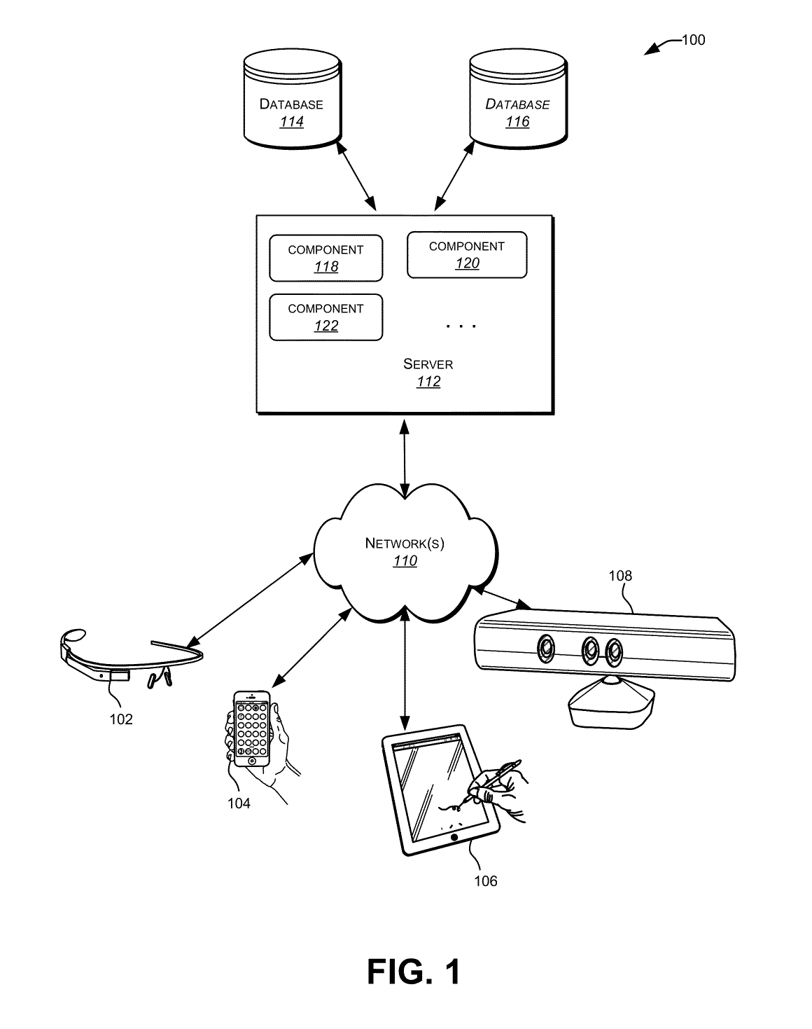

FIG. 1 is a block diagram illustrating components of an exemplary distributed system in which various embodiments of the present invention may be implemented. In the illustrated embodiment, distributed system 100 includes one or more client computing devices 102, 104, 106, and 108, which are configured to execute and operate a client application such as a web browser, proprietary client, or the like over one or more network(s) 110. Server 112 may be communicatively coupled with remote client computing devices 102, 104, 106, and 108 via network 110.

In various embodiments, server 112 may be adapted to run one or more services or software applications provided by one or more of the components of the system. In some embodiments, these services may be offered as web-based or cloud services or under a Software as a Service (SaaS) model to the users of client computing devices 102, 104, 106, and/or 108. Users operating client computing devices 102, 104, 106, and/or 108 may in turn utilize one or more client applications to interact with server 112 to utilize the services provided by these components.

In the configuration depicted in the figure, the software components 118, 120 and 122 of system 100 are shown as being implemented on server 112. In other embodiments, one or more of the components of system 100 and/or the services provided by these components may also be implemented by one or more of the client computing devices 102, 104, 106, and/or 108. Users operating the client computing devices may then utilize one or more client applications to use the services provided by these components. These components may be implemented in hardware, firmware, software, or combinations thereof. It should be appreciated that various different system configurations are possible, which may be different from distributed system 100. The embodiment shown in the figure is thus one example of a distributed system for implementing an embodiment system and is not intended to be limiting.

Client computing devices 102, 104, 106, and/or 108 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 102, 104, 106, and 108 may be any other electronic device, such as a thin-client computer, an Internet-enabled gaming system (e.g., a Microsoft Xbox gaming console with or without a Kinect® gesture input device), and/or a personal messaging device, capable of communicating over network(s) 110.

Although exemplary distributed system 100 is shown with four client computing devices, any number of client computing devices may be supported. Other devices, such as devices with sensors, etc., may interact with server 112.

Network(s) 110 in distributed system 100 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 110 can be a local area network (LAN), such as one based on Ethernet, Token-Ring and/or the like. Network(s) 110 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 112 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 112 may be adapted to run one or more services or software applications described in the foregoing disclosure. For example, server 112 may correspond to a server for performing processing described above according to an embodiment of the present disclosure.

Server 112 may run an operating system including any of those discussed above, as well as any commercially available server operating system. Server 112 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 112 may include one or more applications to analyze and consolidate data feeds and/or event updates received from users of client computing devices 102, 104, 106, and 108. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 112 may also include one or more applications to display the data feeds and/or real-time events via one or more display devices of client computing devices 102, 104, 106, and 108.

Distributed system 100 may also include one or more databases 114 and 116. Databases 114 and 116 may reside in a variety of locations. By way of example, one or more of databases 114 and 116 may reside on a non-transitory storage medium local to (and/or resident in) server 112. Alternatively, databases 114 and 116 may be remote from server 112 and in communication with server 112 via a network-based or dedicated connection. In one set of embodiments, databases 114 and 116 may reside in a storage-area network (SAN). Similarly, any necessary files for performing the functions attributed to server 112 may be stored locally on server 112 and/or remotely, as appropriate. In one set of embodiments, databases 114 and 116 may include relational databases that are adapted to store, update, and retrieve data in response to SQL-formatted commands.

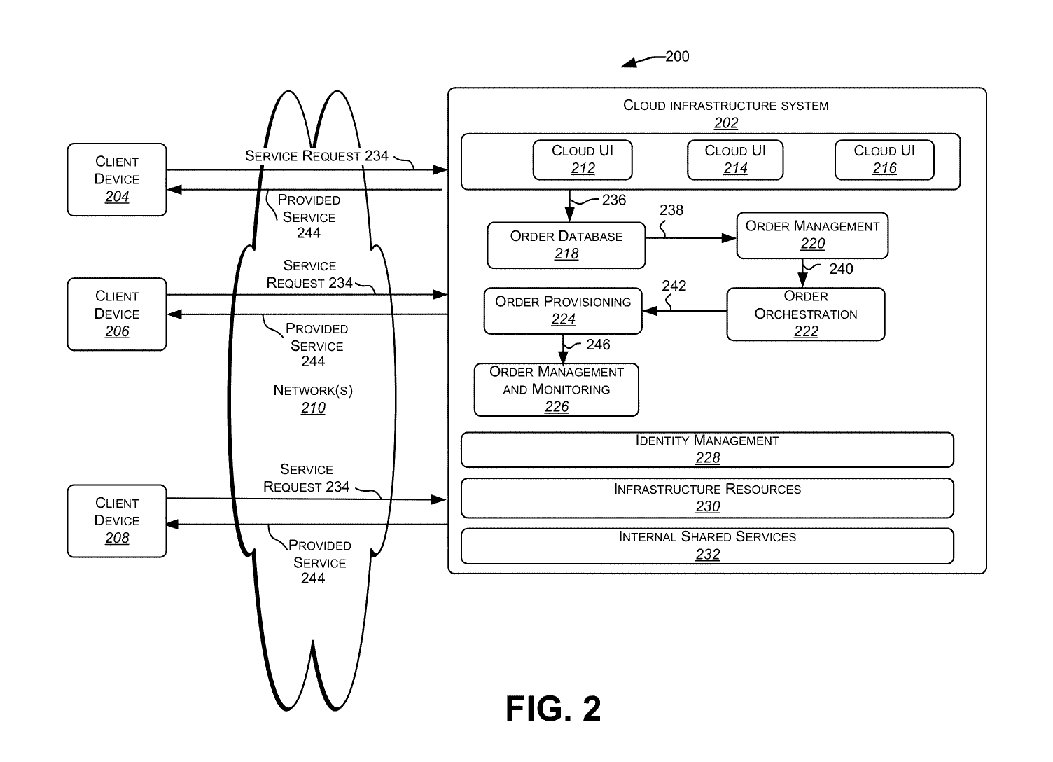

FIG. 2 is a block diagram illustrating components of a system environment by which services provided by embodiments of the present invention may be offered as cloud services. In the illustrated embodiment, system environment 200 includes one or more client computing devices 204, 206, and 208 that may be used by users to interact with a cloud infrastructure system 202 that provides cloud services. The client computing devices may be configured to operate a client application such as a web browser, a proprietary client application, or some other application, which may be used by a user of the client computing device to interact with cloud infrastructure system 202 to use services provided by cloud infrastructure system 202.

It should be appreciated that cloud infrastructure system 202 depicted in the figure may have other components than those depicted. Further, the embodiment shown in the figure is only one example of a cloud infrastructure system that may incorporate an embodiment of the invention. In some other embodiments, cloud infrastructure system 202 may have more or fewer components than shown in the figure, may combine two or more components, or may have a different configuration or arrangement of components.

Client computing devices 204, 206, and 208 may be devices similar to those described above for 102, 104, 106, and 108.

Although exemplary system environment 200 is shown with three client computing devices, any number of client computing devices may be supported. Other devices such as devices with sensors, etc. may interact with cloud infrastructure system 202.

Network(s) 210 may facilitate communications and exchange of data between clients 204, 206, and 208 and cloud infrastructure system 202. Each network may be any type of network familiar to those skilled in the art that can support data communications using any of a variety of commercially-available protocols, including those described above for network(s) 110.

Cloud infrastructure system 202 may comprise one or more computers and/or servers that may include those described above for server 112.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 202 may include a suite of applications, middleware, and database service offerings that are delivered to a customer in a self-service, subscription-based, elastically scalable, reliable, highly available, and secure manner.

In various embodiments, cloud infrastructure system 202 may be adapted to automatically provision, manage and track a customer's subscription to services offered by cloud infrastructure system 202. Cloud infrastructure system 202 may provide the cloud services via different deployment models. For example, services may be provided under a public cloud model in which cloud infrastructure system 202 is owned by an organization selling cloud services and the services are made available to the general public or different industry enterprises. As another example, services may be provided under a private cloud model in which cloud infrastructure system 202 is operated solely for a single organization and may provide services for one or more entities within the organization. The cloud services may also be provided under a community cloud model in which cloud infrastructure system 202 and the services provided by cloud infrastructure system 202 are shared by several organizations in a related community. The cloud services may also be provided under a hybrid cloud model, which is a combination of two or more different models.

In some embodiments, the services provided by cloud infrastructure system 202 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 202. Cloud infrastructure system 202 then performs processing to provide the services in the customer's subscription order.

In some embodiments, the services provided by cloud infrastructure system 202 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 202 may also include infrastructure resources 230 for providing the resources used to provide various services to customers of the cloud infrastructure system. In one embodiment, infrastructure resources 230 may include pre-integrated and optimized combinations of hardware, such as servers, storage, and networking resources to execute the services provided by the PaaS platform and the SaaS platform.

In some embodiments, resources in cloud infrastructure system 202 may be shared by multiple users and dynamically re-allocated per demand. Additionally, resources may be allocated to users in different time zones. For example, cloud infrastructure system 230 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 232 may be provided that are shared by different components or modules of cloud infrastructure system 202 and by the services provided by cloud infrastructure system 202. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 202 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 202, and the like.

In one embodiment, as depicted in the figure, cloud management functionality may be provided by one or more modules, such as an order management module 220, an order orchestration module 222, an order provisioning module 224, an order management and monitoring module 226, and an identity management module 228. These modules may include or be provided using one or more computers and/or servers, which may be general purpose computers, specialized server computers, server farms, server clusters, or any other appropriate arrangement and/or combination.

In exemplary operation 234, a customer using a client device, such as client device 204, 206 or 208, may interact with cloud infrastructure system 202 by requesting one or more services provided by cloud infrastructure system 202 and placing an order for a subscription for one or more services offered by cloud infrastructure system 202. In certain embodiments, the customer may access a cloud User Interface (UI), cloud UI 212, cloud UI 214 and/or cloud UI 216 and place a subscription order via these UIs. The order information received by cloud infrastructure system 202 in response to the customer placing an order may include information identifying the customer and one or more services offered by the cloud infrastructure system 202 that the customer intends to subscribe to.

After an order has been placed by the customer, the order information is received via the cloud UIs, 212, 214 and/or 216.

At operation 236, the order is stored in order database 218. Order database 218 can be one of several databases operated by cloud infrastructure system 218 and operated in conjunction with other system elements.

At operation 238, the order information is forwarded to an order management module 220. In some instances, order management module 220 may be configured to perform billing and accounting functions related to the order, such as verifying the order, and upon verification, booking the order.

At operation 240, information regarding the order is communicated to an order orchestration module 222. Order orchestration module 222 may utilize the order information to orchestrate the provisioning of services and resources for the order placed by the customer. In some instances, order orchestration module 222 may orchestrate the provisioning of resources to support the subscribed services using the services of order provisioning module 224.

In certain embodiments, order orchestration module 222 enables the management of business processes associated with each order and applies business logic to determine whether an order should proceed to provisioning. At operation 242, upon receiving an order for a new subscription, order orchestration module 222 sends a request to order provisioning module 224 to allocate resources and configure those resources needed to fulfill the subscription order. Order provisioning module 224 enables the allocation of resources for the services ordered by the customer. Order provisioning module 224 provides a level of abstraction between the cloud services provided by cloud infrastructure system 200 and the physical implementation layer that is used to provision the resources for providing the requested services. Order orchestration module 222 may thus be isolated from implementation details, such as whether or not services and resources are actually provisioned on the fly or pre-provisioned and only allocated/assigned upon request.

At operation 244, once the services and resources are provisioned, a notification of the provided service may be sent to customers on client devices 204, 206 and/or 208 by order provisioning module 224 of cloud infrastructure system 202.

At operation 246, the customer's subscription order may be managed and tracked by an order management and monitoring module 226. In some instances, order management and monitoring module 226 may be configured to collect usage statistics for the services in the subscription order, such as the amount of storage used, the amount data transferred, the number of users, and the amount of system up time and system down time.

In certain embodiments, cloud infrastructure system 200 may include an identity management module 228. Identity management module 228 may be configured to provide identity services, such as access management and authorization services in cloud infrastructure system 200. In some embodiments, identity management module 228 may control information about customers who wish to utilize the services provided by cloud infrastructure system 202. Such information can include information that authenticates the identities of such customers and information that describes which actions those customers are authorized to perform relative to various system resources (e.g., files, directories, applications, communication ports, memory segments, etc.) Identity management module 228 may also include the management of descriptive information about each customer and about how and by whom that descriptive information can be accessed and modified.

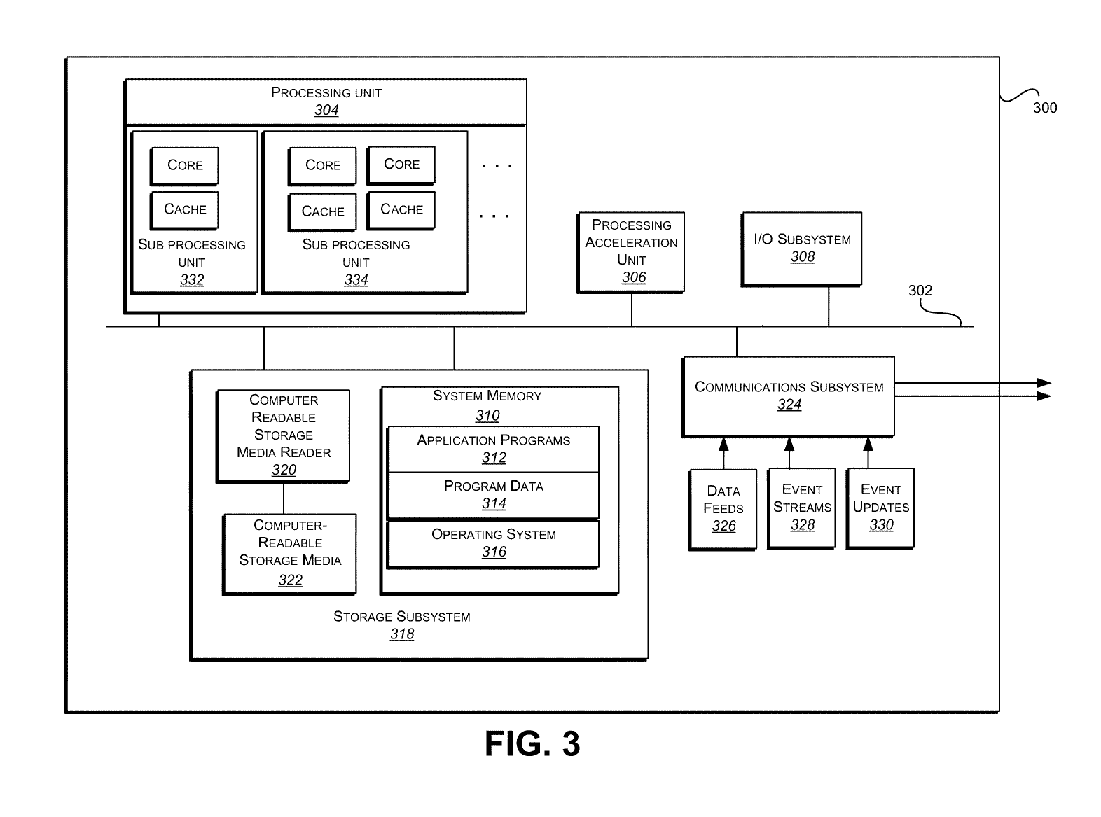

FIG. 3 is a block diagram illustrating an exemplary computer system in which embodiments of the present invention may be implemented. The system 300 may be used to implement any of the computer systems described above. As shown in the figure, computer system 300 includes a processing unit 304 that communicates with a number of peripheral subsystems via a bus subsystem 302. These peripheral subsystems may include a processing acceleration unit 306, an I/O subsystem 308, a storage subsystem 318 and a communications subsystem 324. Storage subsystem 318 includes tangible computer-readable storage media 322 and a system memory 310.

Bus subsystem 302 provides a mechanism for letting the various components and subsystems of computer system 300 communicate with each other as intended. Although bus subsystem 302 is shown schematically as a single bus, alternative embodiments of the bus subsystem may utilize multiple buses. Bus subsystem 302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA

(EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 304, which can be implemented as one or more integrated circuits (e.g., a conventional microprocessor or microcontroller), controls the operation of computer system 300. One or more processors may be included in processing unit 304. These processors may include single core or multicore processors. In certain embodiments, processing unit 304 may be implemented as one or more independent processing units 332 and/or 334 with single or multicore processors included in each processing unit. In other embodiments, processing unit 304 may also be implemented as a quad-core processing unit formed by integrating two dual-core processors into a single chip.

In various embodiments, processing unit 304 can execute a variety of programs in response to program code and can maintain multiple concurrently executing programs or processes. At any given time, some or all of the program code to be executed can be resident in processor(s) 304 and/or in storage subsystem 318. Through suitable programming, processor(s) 304 can provide various functionalities described above. Computer system 300 may additionally include a processing acceleration unit 306, which can include a digital signal processor (DSP), a special-purpose processor, and/or the like.

I/O subsystem 308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 300 may comprise a storage subsystem 318 that comprises software elements, shown as being currently located within a system memory 310. System memory 310 may store program instructions that are loadable and executable on processing unit 304, as well as data generated during the execution of these programs.

Depending on the configuration and type of computer system 300, system memory 310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 304. In some implementations, system memory 310 may include multiple different types of memory, such as static random access memory (SRAM) or dynamic random access memory (DRAM). In some implementations, a basic input/output system (BIOS), containing the basic routines that help to transfer information between elements within computer system 300, such as during start-up, may typically be stored in the ROM. By way of example, and not limitation, system memory 310 also illustrates application programs 312, which may include client applications, Web browsers, mid-tier applications, relational database management systems (RDBMS), etc., program data 314, and an operating system 316. By way of example, operating system 316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 318 may also provide a tangible computer-readable storage medium for storing the basic programming and data constructs that provide the functionality of some embodiments. Software (programs, code modules, instructions) that when executed by a processor provide the functionality described above may be stored in storage subsystem 318. These software modules or instructions may be executed by processing unit 304. Storage subsystem 318 may also provide a repository for storing data used in accordance with the present invention.

Storage subsystem 300 may also include a computer-readable storage media reader 320 that can further be connected to computer-readable storage media 322. Together and, optionally, in combination with system memory 310, computer-readable storage media 322 may comprehensively represent remote, local, fixed, and/or removable storage devices plus storage media for temporarily and/or more permanently containing, storing, transmitting, and retrieving computer-readable information.

Computer-readable storage media 322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 300.

By way of example, computer-readable storage media 322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 322 may include, but is not limited to, Zip® drives, flash memory cards, universal serial bus (USB) flash drives, secure digital (SD) cards, DVD disks, digital video tape, and the like. Computer-readable storage media 322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 300.

Communications subsystem 324 provides an interface to other computer systems and networks. Communications subsystem 324 serves as an interface for receiving data from and transmitting data to other systems from computer system 300. For example, communications subsystem 324 may enable computer system 300 to connect to one or more devices via the Internet. In some embodiments communications subsystem 324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 324 can provide wired network connectivity (e.g., Ethernet) in addition to or instead of a wireless interface.

In some embodiments, communications subsystem 324 may also receive input communication in the form of structured and/or unstructured data feeds 326, event streams 328, event updates 330, and the like on behalf of one or more users who may use computer system 300.

By way of example, communications subsystem 324 may be configured to receive data feeds 326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 324 may also be configured to receive data in the form of continuous data streams, which may include event streams 328 of real-time events and/or event updates 330, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 324 may also be configured to output the structured and/or unstructured data feeds 326, event streams 328, event updates 330, and the like to one or more databases that may be in communication with one or more streaming data source computers coupled to computer system 300.

Computer system 300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

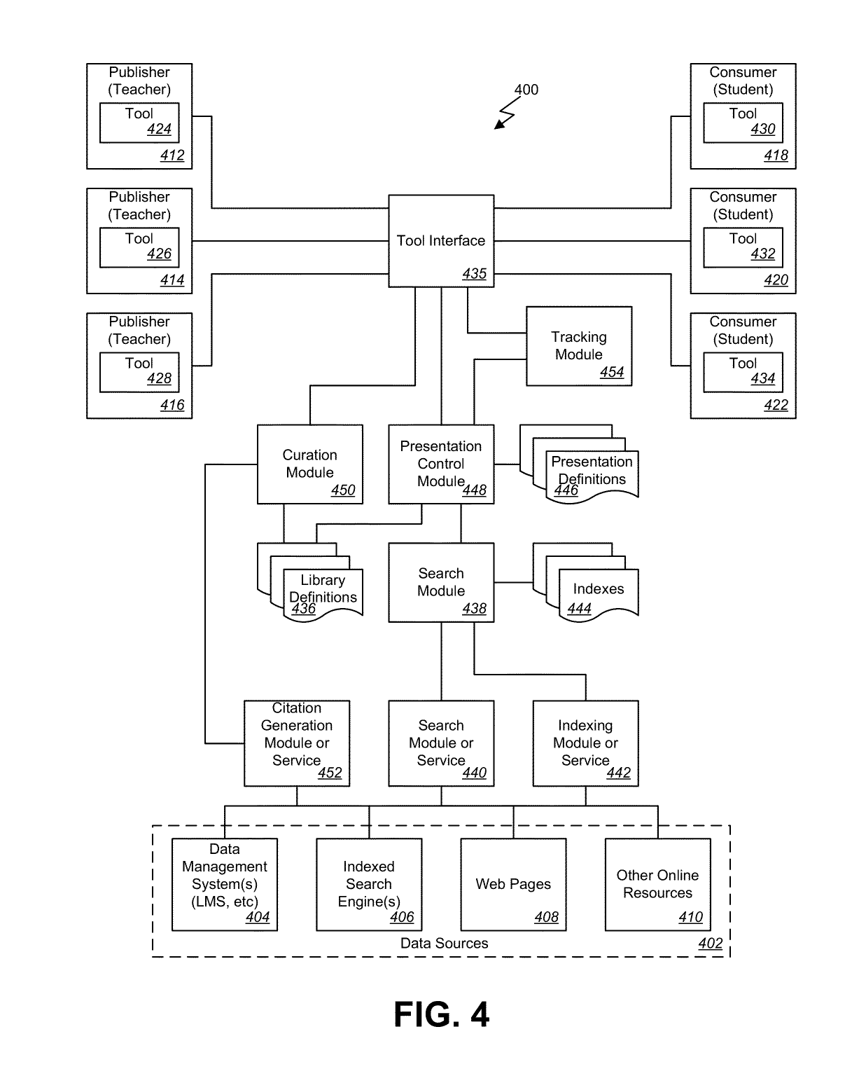

FIG. 4 is a block diagram illustrating, at a high-level, functional components of a system for locating, curating, editing, tracking, reporting, storing, interacting with, and using content within and of an online library according to one embodiment of the present invention. This system 400 can be implemented on or using any of the computers, devices, networks, etc. described above. As illustrated in this example, the system 400 can interact with any of a variety of data sources 402 such as a Learning Management System (LMS) 404, indexed search engines 406, web pages 408, and other online resources 410 that can be provided by any one or more of the servers or other systems described above. It should be noted that while embodiments described herein make reference to an LMS 404, other types of systems may utilize various embodiments of the present invention depending upon the exact implementation. For example, other implementations may be utilized with a Content Management System (CMS), Learning Record Store (LRS), Student Information System (SIS), etc. or without any of the foregoing.

Generally speaking, embodiments of the present invention allow one or more publishers 412, 414, and 416 of content such as teachers to identify and/or create content for one or more consumers 418, 420, 422 of that content such as students in a course or for learning paths. More specifically, embodiments include a tool 424, 426, 428, 430, 432, and 434 comprising a client-side application, applet, app, application extension, etc., executing on the client devices of the publishers 412, 414, and 416 and consumers 418, 420, 422. Features and functions provided by this tool 424, 426, 428, 430, 432, and 434 and described below can be supported by other elements of the system 400 accessible by the tool 424, 426, 428, 430, 432, and 434 through a tool interface 435. Generally speaking, the tool interface 435 can comprise an Application Program Interface (API) or other interface supporting calls or other connections from the client-side tool 424, 426, 428, 430, 432, and 434 to the other components of the system 400 as well as providing data from the other components of the system to the tool 424, 426, 428, 430, 432, and 434 and/or client systems. Through the tool 424, 426, 428, 430, 432, and 434 the teachers/publishers 412, 414, and 416 can assign courses or learning projects (e.g., research) to individual students or groups of students/consumers 418, 420, and 422. The tool 424, 426, 428, 430, 432, and 434 can then allow those individuals to launch the course or learning project or path and track their progress against that course or learning project, e.g., time spent, progress made, scores achieved, search results obtained, websites or databases searched, etc. That tracked progress can be compiled into a learning profile of the individual consumer/student and accessible by the individual consumer/student and the applicable publisher/teacher.

More specifically, the tool 424, 426, 428, 430, 432, and 434 can allow the publishers/teachers to identify content from any of a variety of data sources 405, to be curated to a set of library definitions 436. This content can be found by a search module 438 which may use an external search engine or service 440 to identify the content from the different data sources 405. Once identified, the content can be indexed using an indexing module or service 442 to create a set of indexes 444 that identify and link to the content so that the content can be maintained on the original data source but can be available for an indexed search by the system 400 later.

The teachers can also augment this content or create entirely new content which can also be represented in the library definitions 436 and/or a set of presentation definitions 446. Generally speaking, the presentation definitions 446 can comprise definitions of an overlay layer to be added to the content identified or defined in the library definitions 436 and/or indexes 444 when presented to the students by a presentation control module 448 through an interface such as one or more web pages. According to one implementation, the library definitions 436 and/or presentation definitions 446 can be packaged for delivery according to the “Sharable Content Object Reference Model (SCORM) and/or tracked according to the Tin Can API standard.

According to one embodiment, the functions provided by the tool 424, 426, 428, 430, 432, and 434 can include functions related to and facilitating content searching. To facilitate content searching, the tool 424, 426, 428, 430, 432, and 434 can provide a search dialog in addition to the web browser main window presented on the teacher's or student's client device. This tool 424, 426, 428, 430, 432, and 434 can also support pin-able/persistent access to current searches, provide advanced search functions for filtering results, and/or maintains a search history with links to previous searches. The tool 424, 426, 428, 430, 432, and 434 can also provide library access including searching and/or browsing of existing content of the library through the tool 424, 426, 428, 430, 432, and 434 rather than through the main window of the browser. In use, these functions of the tool 424, 426, 428, 430, 432, and 434 can capture search terms, run in background searching against content of the library, and produce and present a list of results in the form of clickable links to the identified results/contents.

Additionally or alternatively, the functions provided by the tool 424, 426, 428, 430, 432, and 434 can include functions related to and facilitating content capture or curating. For example and according to one embodiment, the tool 424, 426, 428, 430, 432, and 434 can automatically collect information about the current content of the main window of the browser. The collected information can include but is not limited to information such as title, URL, date and time, a thumbnail image, etc. The tool 424, 426, 428, 430, 432, and 434 may, in some cases, collect the full stylized HTML of the content of the main window for caching and use in case the live content is no longer available. The content identified by the tool 424, 426, 428, 430, 432, and 434 can be added to the library definitions 436 by the tool 424, 426, 428, 430, 432, and 434 and/or by a curation module 450. In some cases, such as with content that may be subject to copyright protection, rather than saving the actual content, the URI or other link to or location of the content can be saved for later redirecting a viewer to the original content.

The tool 424, 426, 428, 430, 432, and 434 and/or curation module 450 can also provide a function to allow annotation of the content including the ability to automatically update (i.e., copy and paste) a summary or other annotations upon selection of portions of the content in the main window of the browser. Once the content has been identified, the tool 424, 426, 428, 430, 432, and 434 can allow selection of a location in the library to which the captured content will be added by the curation module 450. Stated another way, the tool 424, 426, 428, 430, 432, and 434 can provide a bookmarking service that takes information about current pages, stores it, and makes it available later but can also be more sophisticated by going through metadata, pulling out some or all of the metadata to be saved, and generating citations to that content, perhaps in combination with a citation generation module or service 452. It should also be noted that the tool 424, 426, 428, 430, 432, and 434 provides for extracting data from a page to feed to a citation generator but without an API or other specific interface to that page and the annotation of the content can be made as the content is captured. So for example, a teacher can add a note about a captured piece of content and add tags to it, e.g., tag it as belonging to a particular class or subject. It should also be noted that these functions can be performed on content saved in the data management system or the indexed data maintained by other sources.

According to one embodiment, the functions provided by the tool 424, 426, 428, 430, 432, and 434 can include functions related to and facilitating content editing. For example, the tool 424, 426, 428, 430, 432, and 434 can provide an additional editing toolbar accessible from and interactive with the main window of the browser and which provides access to tools for augmenting and contextualizing the captured content including but not limited to a highlighter tool for selecting and marking portions of the content, a note tool for adding notes or comments to the content, a tool for embedding other resources in the content such as content or other resources from the library, a tool for adding other types of content such as a poll or quiz, and/or a tool for adding a user discussion thread embedded in or associated with the content. Content that has been edited or added using any one or more of these tools can also be captured and stored in the library and made available to users. More specifically, these captured edits or additions can be added to the presentation definitions 446 as a presentation layer to be rendered on top of the content to draw attention to important areas of the page or add content to it when it is provided to a student or other consumer of the content. Additionally, the presentation layer ties together the content from the various sources and can make assignment of particular content, at particular steps, to particular groups and/or individuals, i.e., it can define a workflow for a course, for a group of students, for an individual student, etc. In this way, a teacher or other publisher 412, 414, or 416 can direct students or other consumers 418, 420, or 422 of the content to particular information, add explanations of the information in any of a variety of different formats including but not limited to textual explanations, links to other explanatory content, video and/or audio explanations, etc., collect feedback or test understanding though polls and/or quizzes, initiate interaction through discussions, etc. As noted above, for content that may be subject to copyright protection, rather than saving the actual content, the URI or other link to or location of the content can be saved for later redirecting a viewer to the original content. In such cases, annotations, markups, and/or other indications of edits may be saved separate from the content to be retrieved and rendered along with the original content.

According to one embodiment, the functions provided by the tool 424, 426, 428, 430, 432, and 434 can include functions related to and facilitating tracking of a student's or other consumers action related to the content. For example, the tool 424, 426, 428, 430, 432, and 434 can provide for capturing and tracking user access of the content, interactions with that content, results of those interactions, etc. More specifically, once the user launches the tool 424, 426, 428, 430, 432, and 434, the tool 424, 426, 428, 430, 432, and 434 and/or a tracking module 454 can monitor the user's actions and track those actions against the content and steps defined in the presentation layer. For example, the tool 424, 426, 428, 430, 432, and 434 and/or tracking module 454 can track the user moving from page to page, completing a task (e.g., answering questions in a quiz), participating in a discussion forum thread, etc. and report this progress. This can enable model in which a teacher can be given feedback on who is progressing and who may need extra help and allow the teacher to take corrective action sooner.

Other features of the tool 424, 426, 428, 430, 432, and 434 can include a function to manage login information, e.g., usernames, passwords, credentials, etc. for various sites. More specifically, the tool 424, 426, 428, 430, 432, and 434 can detect a user's initial access of a secure site and the login information used to access that site. This information can be maintained, for example in persistent memory at the user's device or elsewhere, for later reuse when the user again attempts to enter that site. On these subsequent accesses of previously visited secure sites, the extension can, for example, auto-populate a login page form with the saved username, password, etc. In other cases, the tool 424, 426, 428, 430, 432, and 434 might automatically complete a login process in a way that is transparent to the user.

Other features of various embodiments can include user interfaces provided by these tools. Even though these interfaces can vary significantly in various implementations, some of the exemplary interfaces may provide particular advantages in efficiency, ease of use, etc. To better explain the functions described above, some exemplary user interfaces are provided in the figures and will be briefly described below. It should be understood that these exemplary interfaces are provided for illustrative purposes only and are not intended to limit the scope of the present invention. Rather, the actual format, content, and other features of the interfaces can vary widely between implementations without departing from the scope of the present invention.

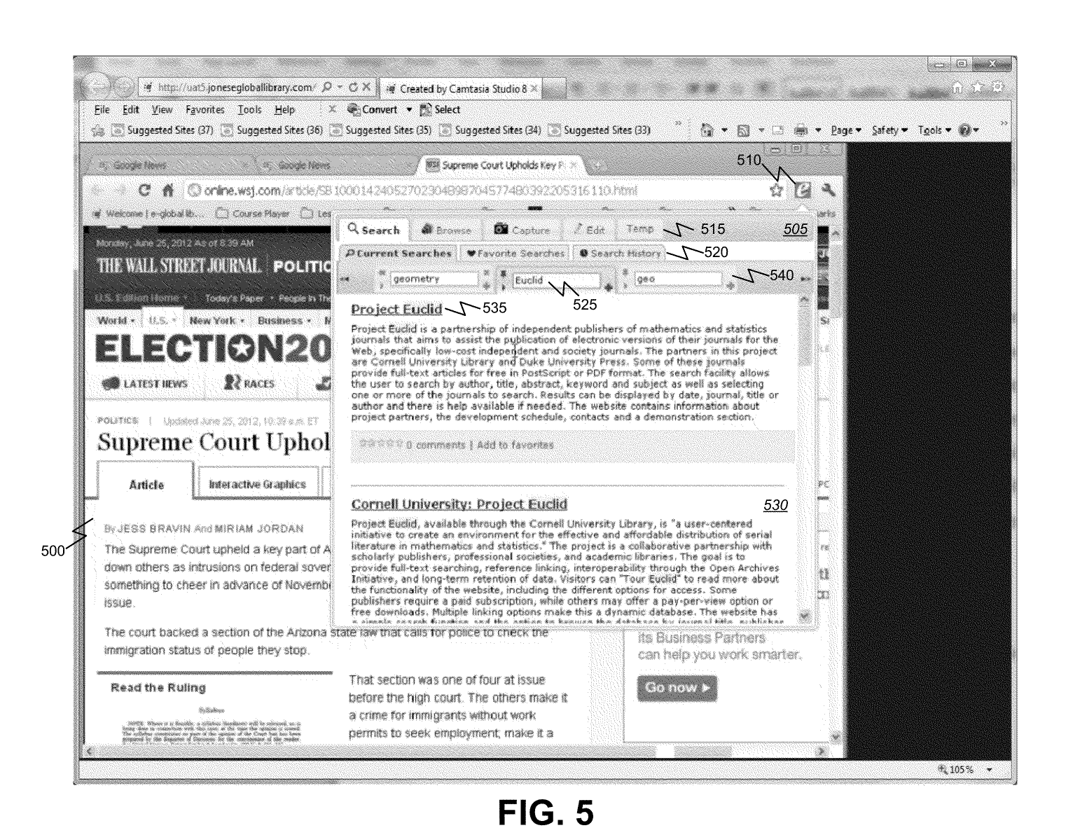

FIG. 5 is a screenshot of an exemplary user interface illustrating a search dialog as may be presented by a tool as described herein. The search dialog 505 may be presented in addition to a main window 500 of a browser. For example, the tool may be represented by an icon 510, button, link, or other element of indication added to a toolbar, menu, or elsewhere on the browser window 500. Upon a selection of the tool, e.g., by clicking the icon 510, the search dialog 505 can be opened, without leaving the content currently being displayed in the browser window 500. Thus, the search can be initiated without navigating away from the current content.

As illustrated in this example, the search dialog 505 can provide access to various features of the tool through a first set of tab markers 515, buttons, links, or other elements. In this case, the “Search” tab is selected providing access to the search functions of the tool. Those functions can also be represented by a second set of tab markers 520, buttons, links, or other elements. According to one embodiment, these tab markers 520 can provide access to “Current Searches,” a set of saved “Favorite Searches,” “and a “Search History.”

In this example, the “Current Searches” tab is selected. The current searches can be represented by a third set of tab markers 540, buttons, links, or other elements representing one or more searches which can be pin-able, i.e., made persistent so that they can be maintained if the user navigates to another search function or tool function and presented again upon return to the “Current Searches” function. Current searches can be pinned or unpinned/removed by user selection of an icon, button, link, or other element of the search dialog 505, for example a represented by the pushpin and X icons on the third set of tabs 540 as illustrated here.

One of the third set of tabs 540 may be selected to show results for the search represented by that tab. As illustrated here, the third set of tabs 540 can include, on the tab marker, a partial or complete representation of the search terms for the represented search. In this case, the tab 525 representing the search for the term “Euclid” is selected. The search dialog 505 thus also includes a representation of results for the search for contents matching this criteria, e.g., including the term. For example the results can include a representation 530 of some or all of a document in which the term occurs and/or a link 535 to a document of other content matching the term.

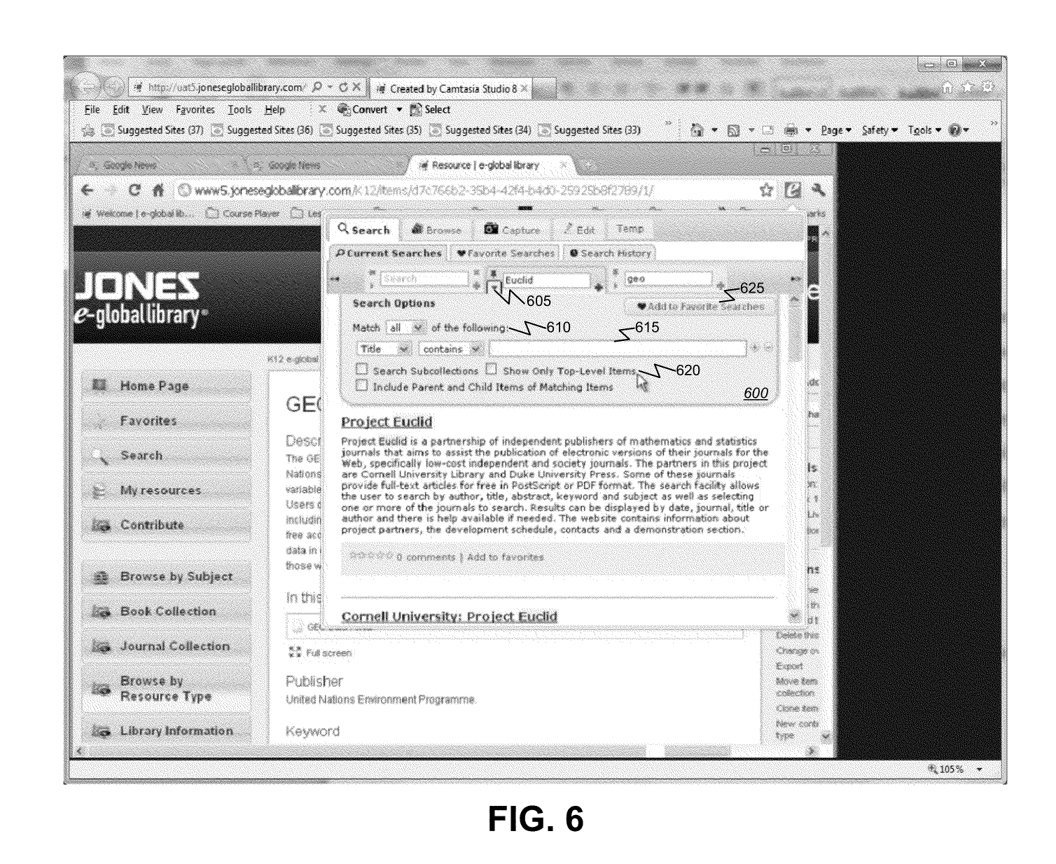

FIG. 6 is a screenshot of an exemplary user interface illustrating the search dialog 505 of FIG. 5 and including additional features for filtering search results according to one embodiment of the present invention. In this example, the tab 525 from the third set of tabs 540 and representing the search for the term “Euclid” is selected as described above. Additionally, a filter dialog 600 has been presented. For example, this dialog 600 can be displayed based on a user clicking or otherwise selecting an icon 605, button, link, or other element which can be display on each of the third set of tabs 540 or elsewhere in the search dialog 505. Once displayed, the filter dialog 600 can provide a number of elements 610, 615, 620 for selecting or otherwise defining criteria for filtering the results of the search represented by the selected tab 525 of the third set of tabs 540. For example, these elements 610, 615, 620 can include any number of text boxes, combo boxes, checkboxes, radio buttons, etc. for selecting or entering values for attributes represented or described by accompanying text for each element. The filter dialog 600 may also include a button 625 or other element for adding the currently selected search, along with any filter criteria that may be defined, to a set of favorite searches so that the search criteria and any filter criteria can be persisted and reused later.

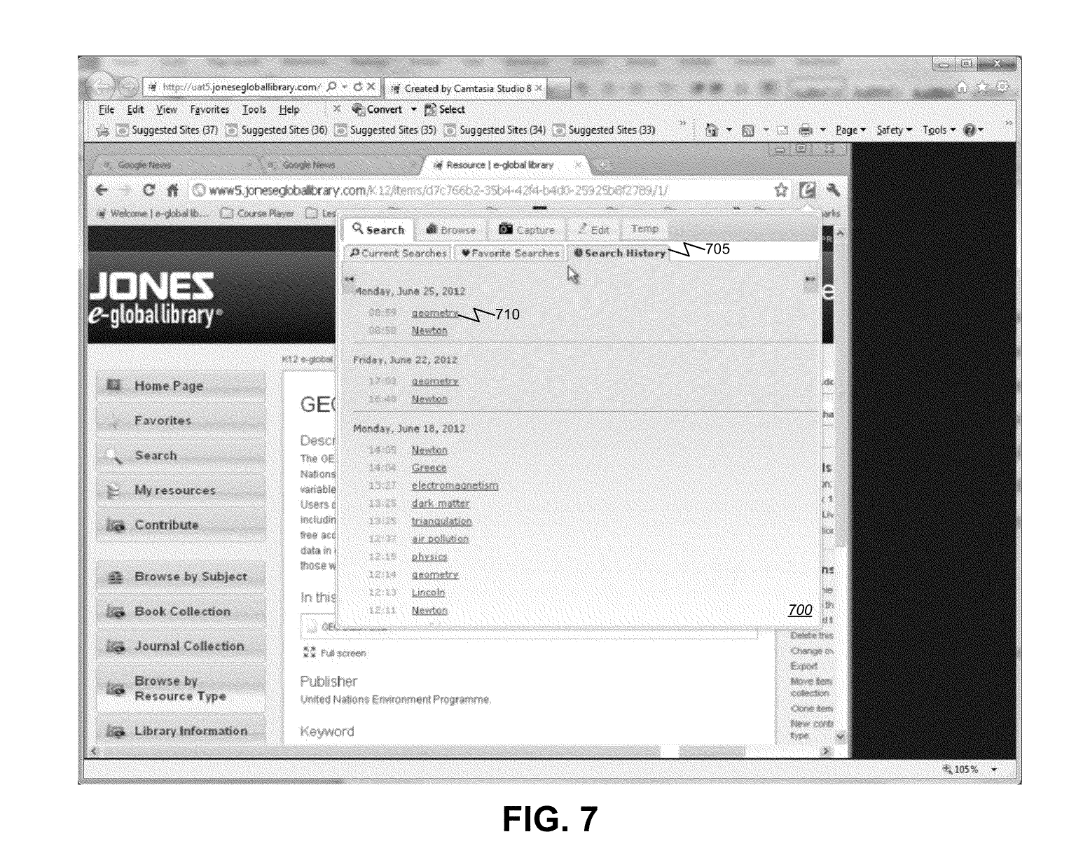

FIG. 7 is a screenshot of an exemplary user interface illustrating the search dialog of FIG. 5 and including a representation of a search history according to one embodiment of the present invention. In this example, the “Search History” tab 705 from the third set of tabs 540 is selected. As a result, a list 700 of prior searches can be presented. The prior searches, i.e., the terms and criteria and any filter conditions defined therefore, can be saved automatically as the searches are performed. The history of searches presented in the list 700 can be arranged and represented chronologically, along with an indication of the day and time the search was performed. Each search in the list 700 can be represented by a link 710 along with a name, e.g., a term used in the search. Upon selection of one of a link 710 from the list 700, that search can be re-executed and the results for that search can be presented in the search dialog as illustrated in and above with reference to FIG. 5. It should be noted that, while not illustrated separately here for the sake of brevity, a list of saved “Favorite Searches” accessible through the third set of tabs 540 can be presented in the form of a list of links in a similar fashion but may be arranged in a different order, e.g., alphabetically on a user defined name or label rather than chronologically.

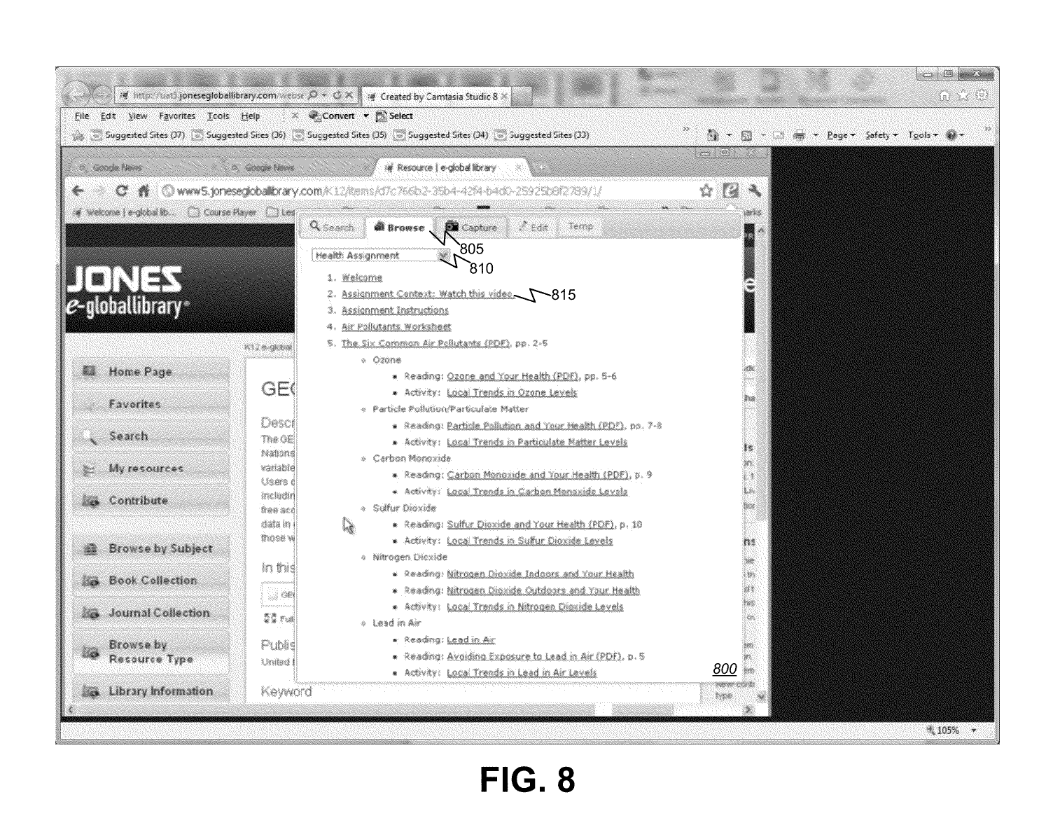

FIG. 8 is a screenshot of an exemplary user interface illustrating a search dialog as described above and wherein the “Browse” tab 805 of the first set of tab markers 515 has been selected by a user wishing to browse or “surf” available content of the online library. As a result, a list 800 of contents of the library can be presented. This list 800 can comprise one or more elements 810 such as a combo box or other element for selecting a topic or category. The resulting list can also include a set of explanatory texts and/or links 815 to content arranged in the form of an index, outline, or syllabus or the content. This index can be predefined by an author of the content or can be generated based on a set of metadata tags or other information associated to the content that defined and/or describe the content of the library.

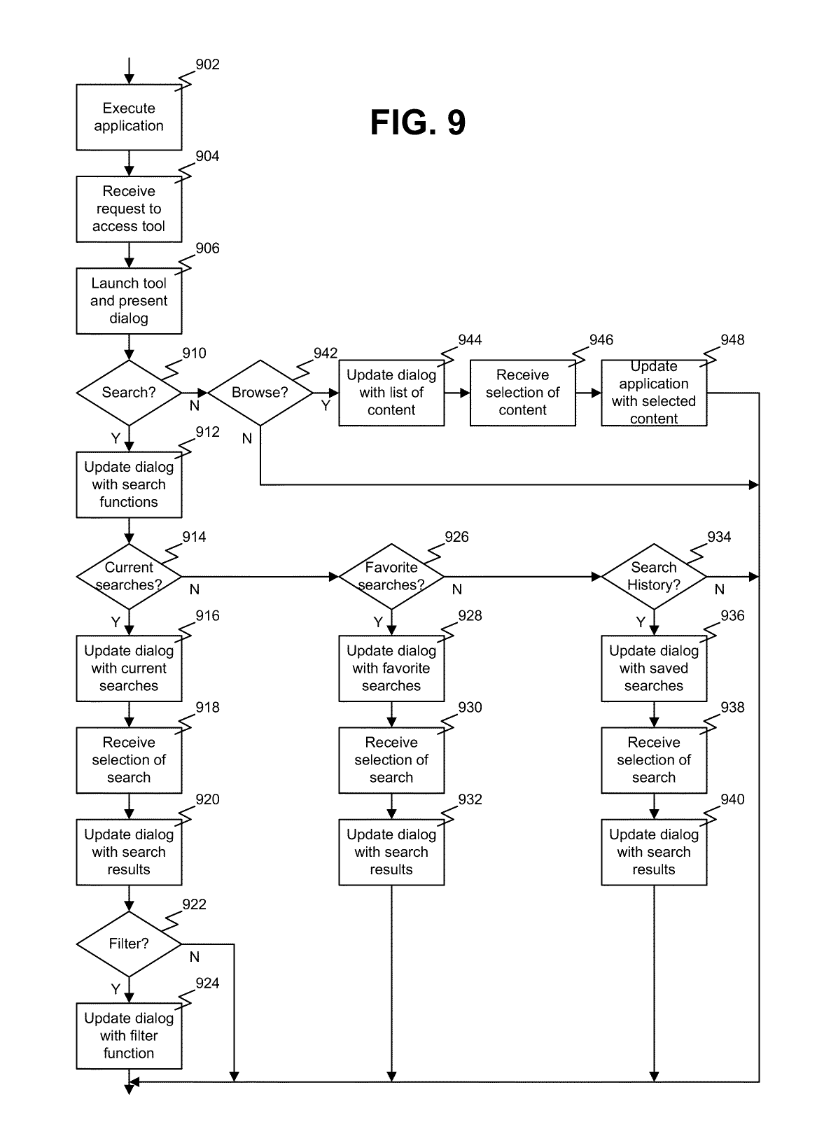

FIG. 9 is a flowchart illustrating a process for locating and using content of an online library according to one embodiment of the present invention. As illustrated in this example, locating and accessing content of an online library can comprise executing 902 an application such as a browser, for example, providing a view of content of the online library. As described above, the application can further provide access to a tool which in turn provides a plurality of functions supported by the online library for locating and accessing the content of the online library. An indication of a user request to access the tool can be received 904 through the application, e.g., by the user clicking or otherwise selecting an icon or link etc. In response to the indication, the tool can be launched 906 through the application. Launching the tool can comprise providing a graphical dialog such as described above including a first plurality of graphical elements representing each of a plurality of features provided by the tool. The plurality of features provided by the tool can include at least a search feature and a browse feature.

An indication of a user selection of one of the first plurality of graphical elements representing the search feature provided by the tool can be received 910 through the graphical dialog. In response to the indication, the graphical dialog can be updated 912 to further include a second plurality of graphical elements representing each of a plurality of search functions provided by the tool.

For example, the plurality of search functions can include a current searches function providing access to one or more searches and corresponding results. In such a case, providing access to one or more searches and corresponding results can comprise receiving 914 through the graphical dialog an indication of a user selection of the graphical indication of the current searches function. In response to the indication, the graphical dialog can be updated 916 to further include a third plurality of graphical elements representing each of one or more current searches. Each of the third plurality of graphical elements can include an identification of the represented current search. An indication of a user selection of one of the third plurality of graphical elements can be received 918 through the graphical dialog. In response to the indication, the graphical dialog can be updated 920 to further include results for the search corresponding to the selected one of the third plurality of graphical elements.

In some cases, the selected one of the third plurality of graphical elements can include a graphical indication of a filter function of the tool. In such cases, an indication of a user selection of the graphical indication of the filter function can be received 922 through the graphical dialog and filtering 924 of the presented search results can be performed. For example, performing 924 filtering of the presented search results can comprise updating the graphical dialog to further include one or more elements for defining filter conditions, receiving filter conditions through the one or more elements for defining the filter conditions, and updating the results for the search corresponding to the selected one of the third plurality of graphical elements based on the received filter conditions.

In another example, the plurality of search functions can include a favorite searches function providing access to one or more prior searches saved by the tool in response to a request from the user. In such cases, an indication of a user selection of one of the second plurality of graphical elements representing the favorite searches function receiving 926 through the graphical dialog. In response to the indication, the graphical dialog can be updated 928 to further include a list including a list identifying and providing access to each of the one or more prior searches. Through this list, for example, a user selection of one of the searches can be received 930 and the graphical dialog can be updated 932 with the results of the selected search.

In yet another example, the plurality of search functions can include a search history function providing access to one or more prior searches saved by the tool automatically. In such cases, an indication of a user selection of one of the second plurality of graphical elements representing the search history function can be received 934 through the graphical dialog. In response to the indication, the graphical dialog can be updated 936 to further include a list identifying and providing access to each of the one or more prior searches. Through this list, for example, a user selection of one of the searches can be received 938 and the graphical dialog can be updated 940 with the results of the selected search.

Additionally or alternatively, an indication of a user selection of one of the first plurality of graphical elements representing the browse feature provided by the tool can be received 942 through the graphical dialog. In response to the indication, the graphical dialog can be updated 944 to include a list identifying and providing access to the content of the online library. Through this list, for example, a user selection of library content can be received 946 and the interface of the application, e.g., the browser main window, can be updated 948 with the selected content.

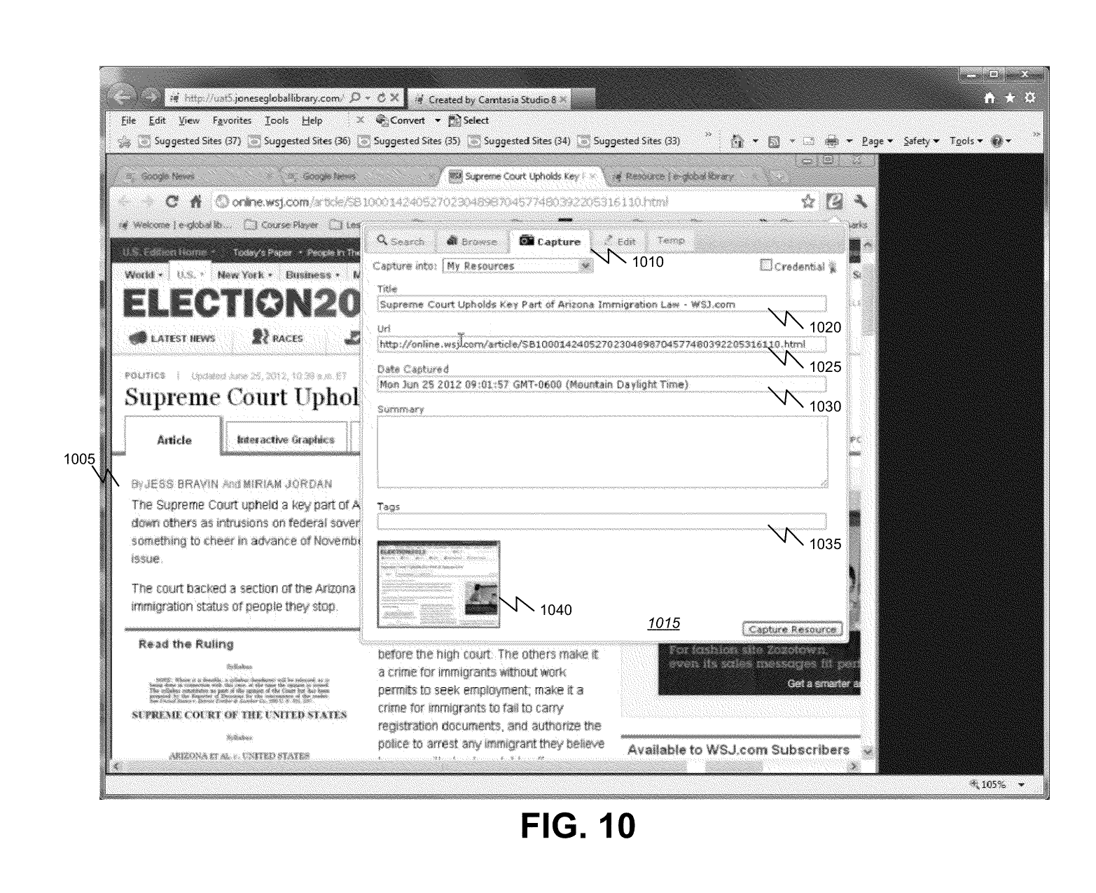

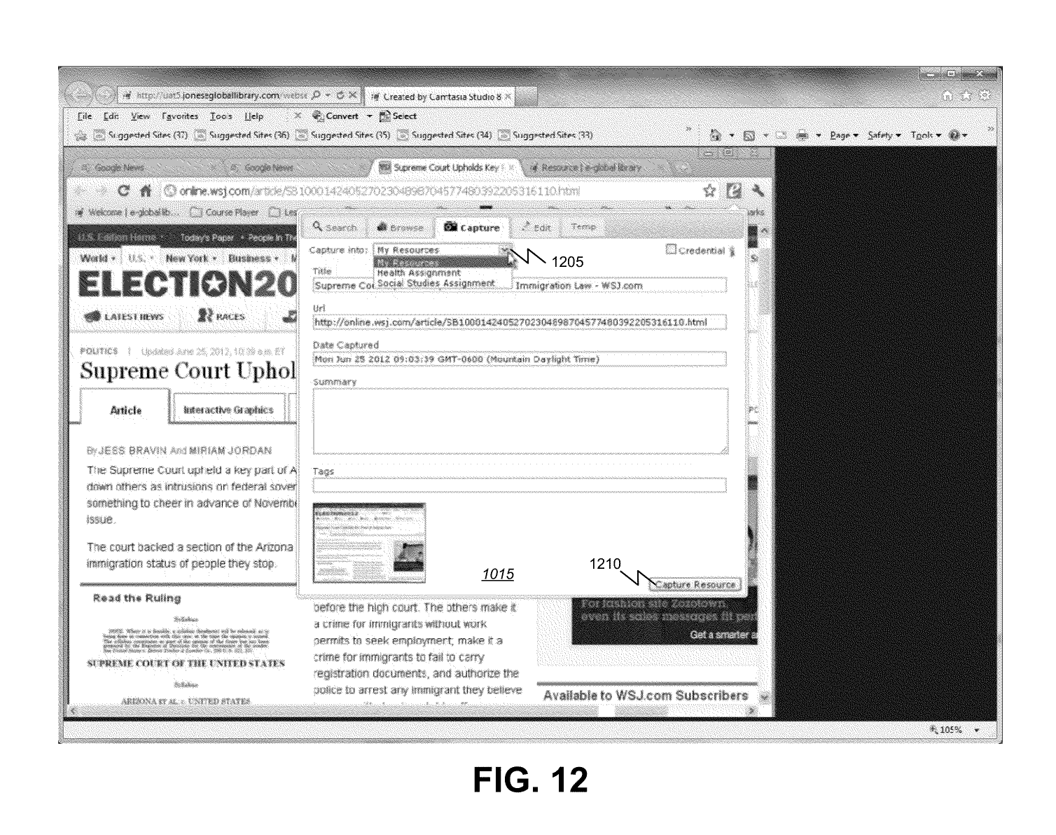

As noted above, the functions provided by embodiments of the present invention can include functions related to and facilitating content capture or curating. For example, the tool described above can automatically collect information about the current content of the main window of the browser. FIGS. 10-12 are a set of screenshots illustrating exemplary user interfaces in which a tool for capturing content of an online library may be implemented according to various embodiments of the present invention.

More specifically, FIG. 10 is a screenshot of an exemplary user interface illustrating curating of content by a tool as described herein. As illustrated in this example, the content capture dialog 1015 may be presented in addition to a main window 1005 of a browser. For example, upon a selection of the tool, e.g., by clicking the icon 510 and the “Capture” tab 1010, the content capture dialog 1015 can be opened, without leaving the content currently being displayed in the browser window 1005 which may include content located using the search tool described above.

As illustrated in this example, the content capture dialog 1015 can include a set of textboxes 1020, 1025, 1030, and 1035, thumbnails 1040, and/or other elements. These elements can represent information about the content of the main window 1005 of the browser that was collected by the tool. For example, the tool can capture and the content capture dialog 1015 can display a title 1020 of the content, a URL or other location 1025 of the content, and a timestamp 1030 the content was captured. The content capture dialog 1015 can also display one or more tags 1035 captured from the content of the main window 1005 of the browser and/or entered by the user and/or a thumbnail image 1040 of the content of the main window 1005 of the browser that was captured. As noted above, the tool can collect the full stylized HTML of the content of the main window 1005 for caching and use if the live content is no longer available.

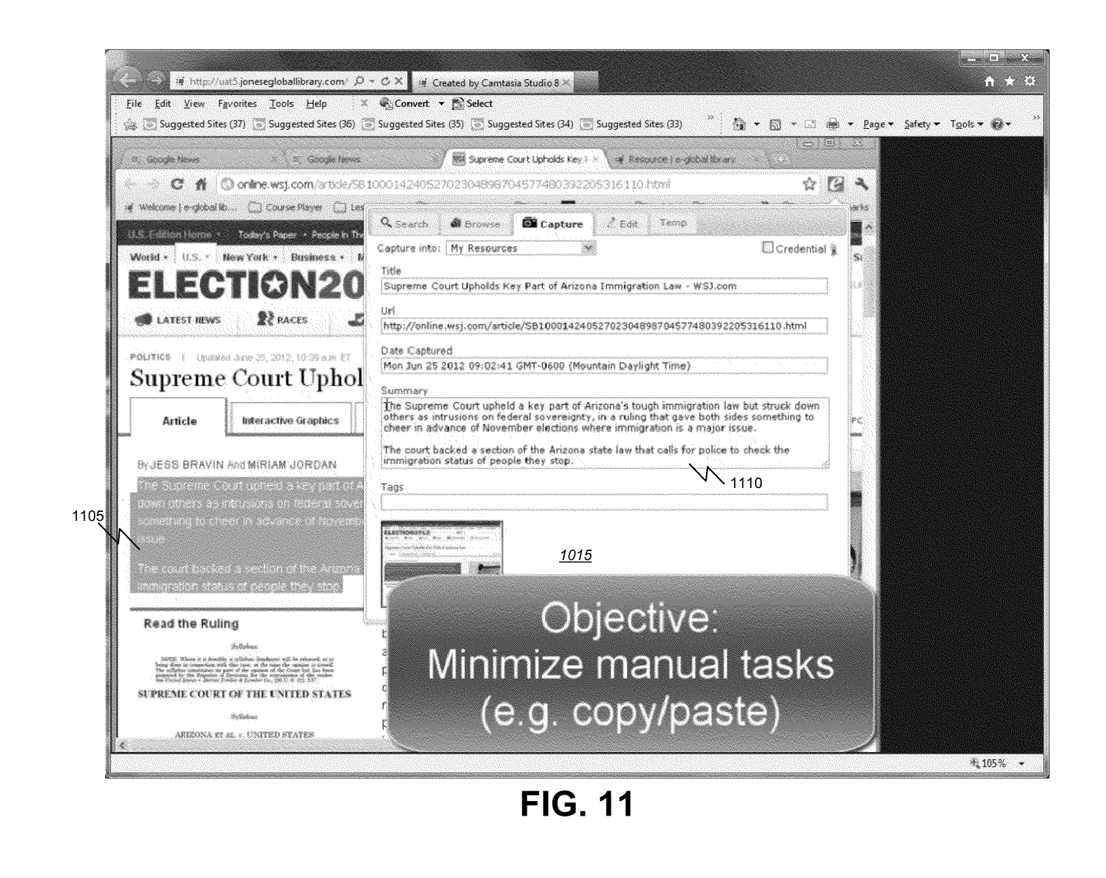

As noted above, the content capture dialog 1015 of the tool can allow annotation of the captured content including the ability to automatically update (i.e., copy and paste) summary or other annotations upon selection of portions of the content in the main window 1015 of the browser. FIG. 11 is a screenshot of an exemplary user interface illustrating annotating of content by a tool as described herein. As illustrated in this example, a portion of the content 1105 can be selected, e.g., by the user manipulating the mouse or other pointing device to highlight or otherwise indicate selection of that portion of content 1105. Upon selection, this content can be used to automatically populated the summary textbox 1110 of the content capture dialog 1015. That is, the summary 1110 can be automatically updated without the user needing to perform a cut and paste operation. In other cases, the summary 1110 may be updated by a typical cut and paste operation or may be directly entered or edited by the user, e.g., through a keyboard etc.

Also as noted, the content capture dialog 1015 of the tool can allow the user to select a location in a library or other repository where the captured content can be saved or curated. FIG. 10 is a screenshot of an exemplary user interface illustrating curating of content to a user selected location as described herein. As illustrated in this example, the content capture dialog 1015 can include a combo-box 1205, textbox, or other element through which the user can select or otherwise specify a location for the captured content to be saved. Upon selection of a “Capture Resource” button 1210 or other element, the content can be saved to the location specified.

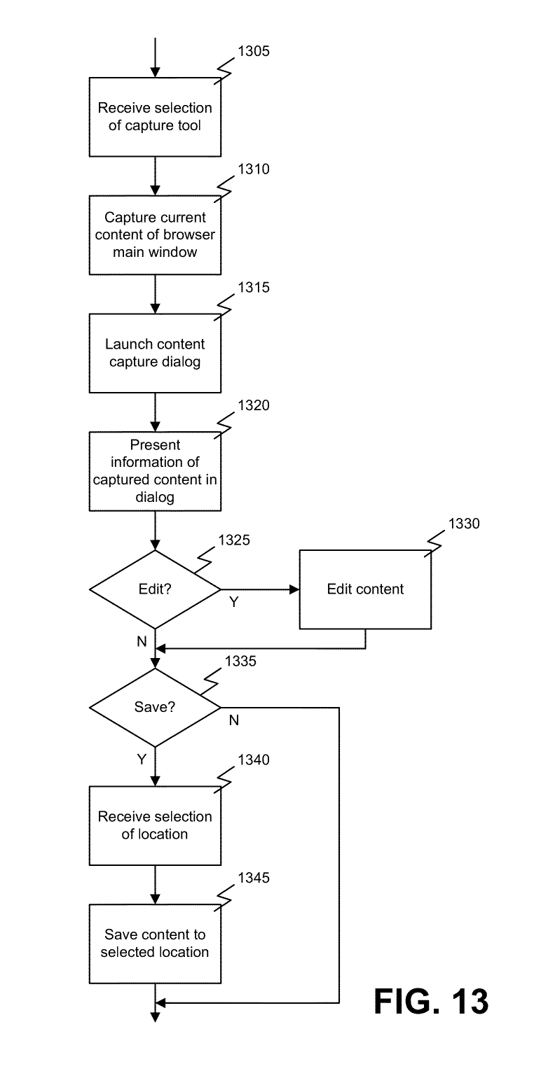

FIG. 13 is a flowchart illustrating a process for capturing content of an online library according to one embodiment of the present invention. As illustrated in this example, capturing the located content through the content capture feature of the tool can comprise receiving 1305 through the graphical dialog an indication of a user selection of one of the first plurality of graphical elements representing the content capture feature provided by the tool. The currently viewed content can be captured 1310 automatically and in response to receiving the user selection and a content capture dialog can be launched 1315. The content capture dialog can comprise a plurality of graphical elements representing information from the captured currently viewed content. The content capture dialog including the plurality of graphical elements representing information from the captured currently viewed content can be presented 1320 to the user within the graphical dialog, e.g., within the representation of the tool displayed by the browser.

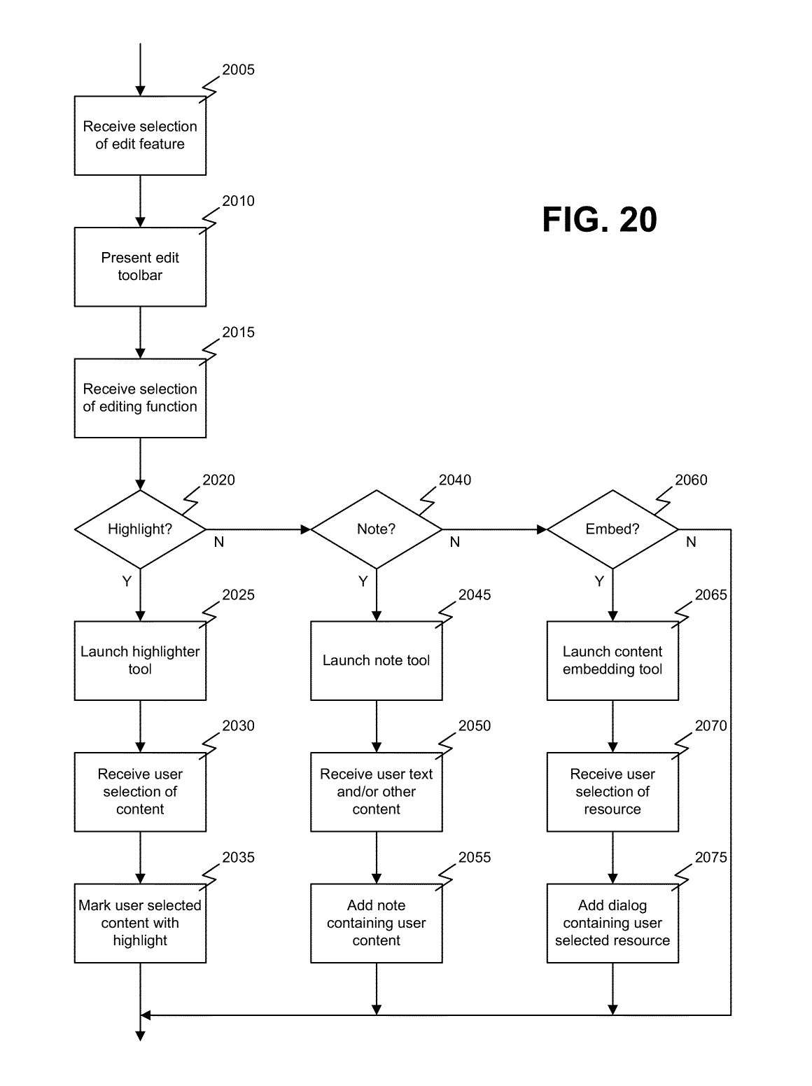

In some cases, this captured content may be edited by the user. In such cases, a determination 1325 may be made as to whether to edit the captured content. This determination 1325 may be based, for example, on a user selection of an “Edit” tab of the graphical representations described above with reference to the Figures or may be based on other user selections or indications. In response to determining 1325 to edit the content, a content editing feature can be launched 1330. Additional details of the content editing feature and various functions thereof will be described below with reference to FIG. 20.

The captured content, either as captured 1310 or as edited 1330 by the user, can be saved to the library or other repository. Thus, a determination 1335 may be made as to whether to save the content. In response to determining 1335 to save the content, an indication of a user selection of a location for saving the content can be received through the content capture dialog. The captured currently viewed and possibly edited content can then be saved at the location indicated by the user selection.

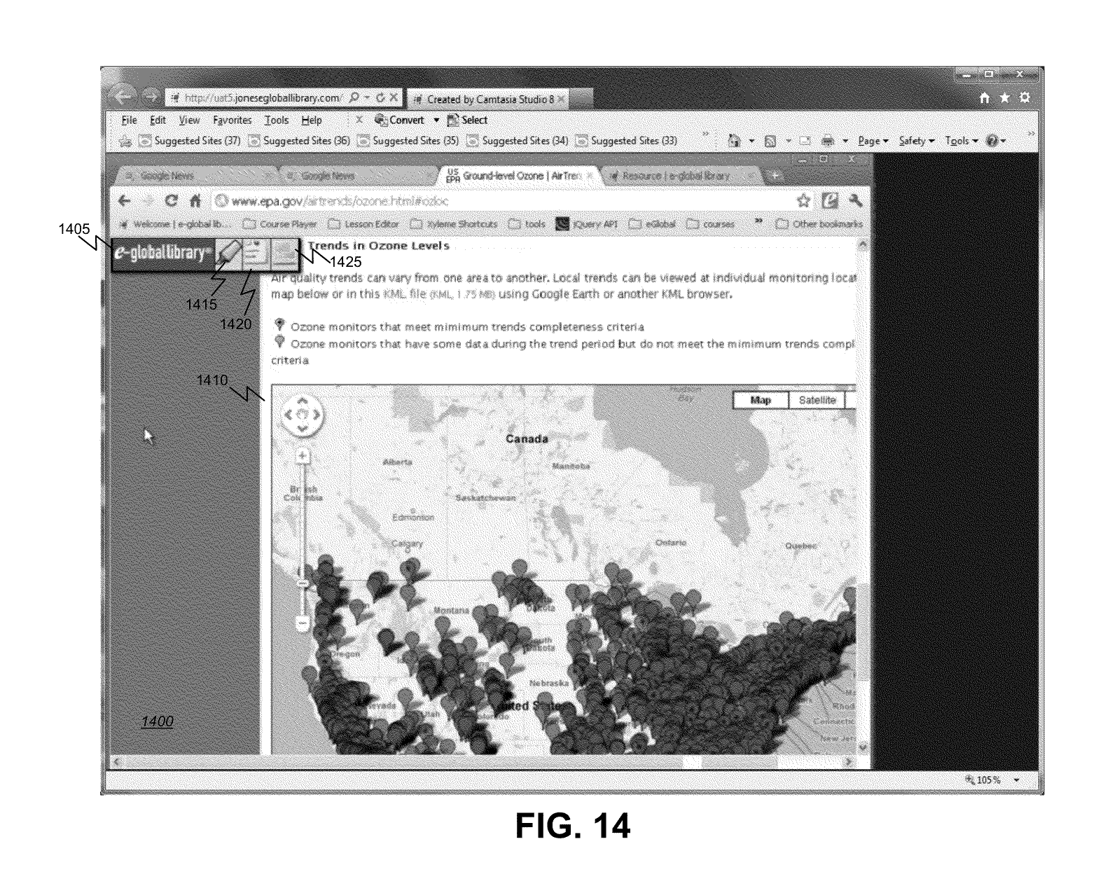

The functions provided embodiments of the present invention can also include functions related to and facilitating content editing. FIGS. 14-19 are a set of screenshots illustrating exemplary user interfaces in which a tool for editing content of an online library may be implemented according to various embodiments of the present invention. More specifically, FIG. 14 is a screenshot of an exemplary user interface illustrating an editing toolbar as may be presented by the tool as described herein. As noted above, the tool can provide an additional editing toolbar 1405 accessible from and interactive with the main window 1400 of the browser and which provides access to tools for augmenting and contextualizing the captured content 1410 including but not limited to a highlighter tool 1415 for selecting and marking portions of the content, a note tool 1420 for adding notes or comments to the content, a tool for embedding 1425 other resources in the content such as content or other resources from the library, a tool for adding other types of content such as a poll or quiz, and/or a tool for adding a user discussion thread embedded in or associated with the content.

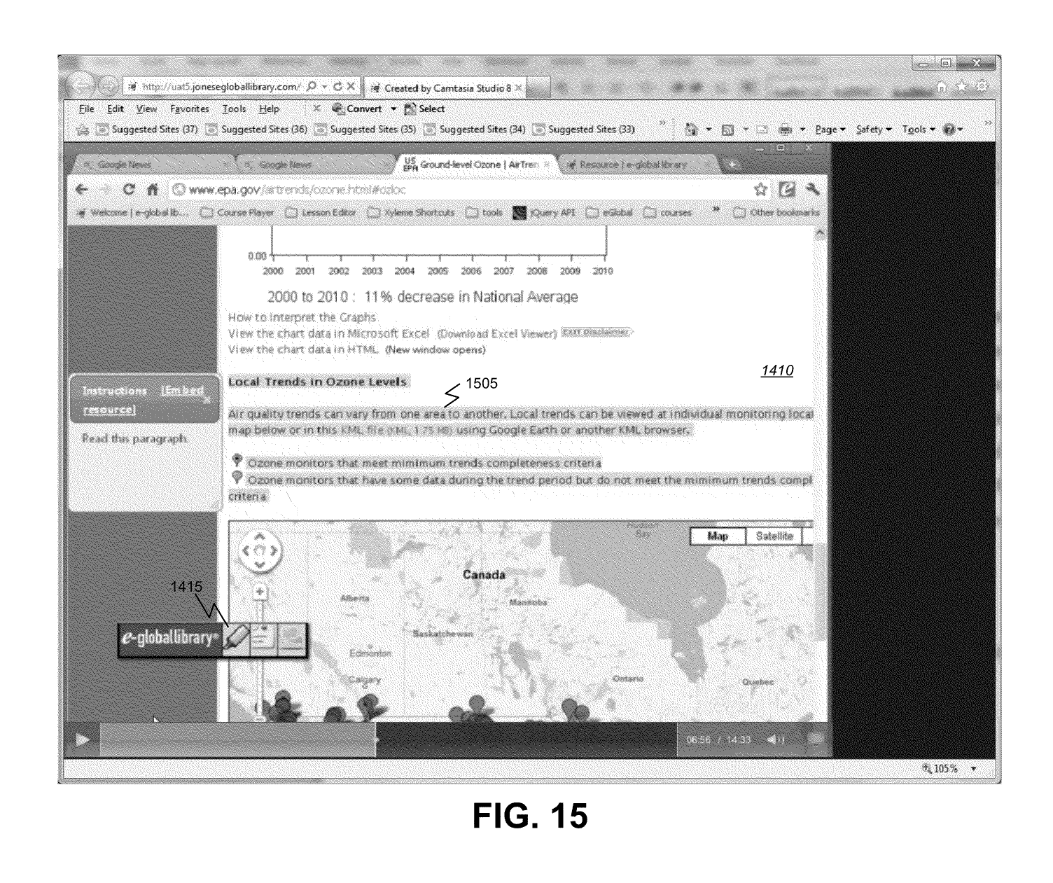

FIG. 15 is a screenshot of an exemplary user interface illustrating use of highlighter tool according to one embodiment of the present invention. As illustrated in this example, a user can select the highlighter tool 1415 from the editing toolbar. Once selected, this tool can then allow the user to manipulate the mouse or other pointing device to select and highlight a portion 1505 of the captured content 1410. Such a tool may be useful, for example, for a teacher or other publisher of the captured content to identify particular parts of the captured content that may be of special interest.

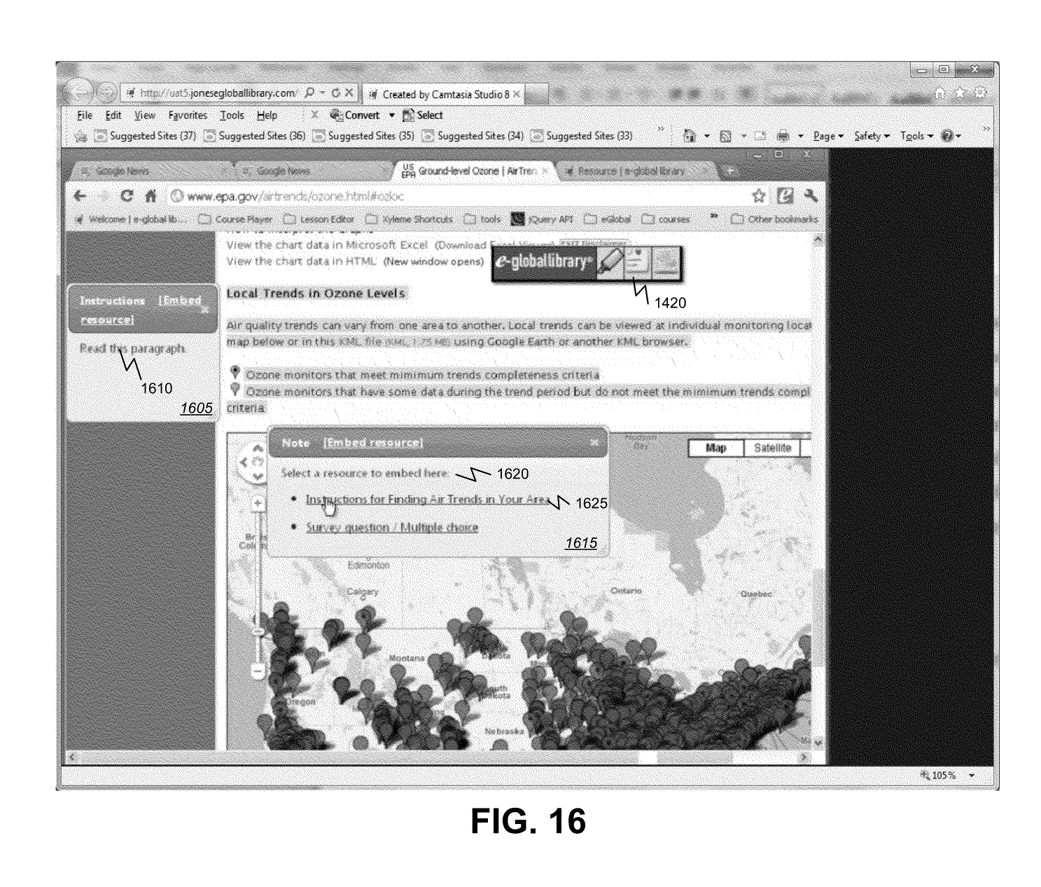

FIG. 16 is a screenshot of an exemplary user interface illustrating embedding notes and/or other resources in the content according to one embodiment. As illustrated in this example, a user can select the note tool 1420 from the editing toolbar. Once selected, this tool 1420 can then allow the user to create one or more notations 1605 and 1615, illustrated here as sticky notes. These notations 1605 and 1610 can include descriptive or explanatory text 1610 and 1620. These notations 1605 and 1610 can also include, in some cases, other resources such as links 1625 to additional content. This additional content can include any of a variety of media and/or formats including but not limited to text, graphics, video, audio, etc. These resources may be added to the notation through any of a variety of operations including but not limited to copy and paste by the user or by the content search and capture operations described above.

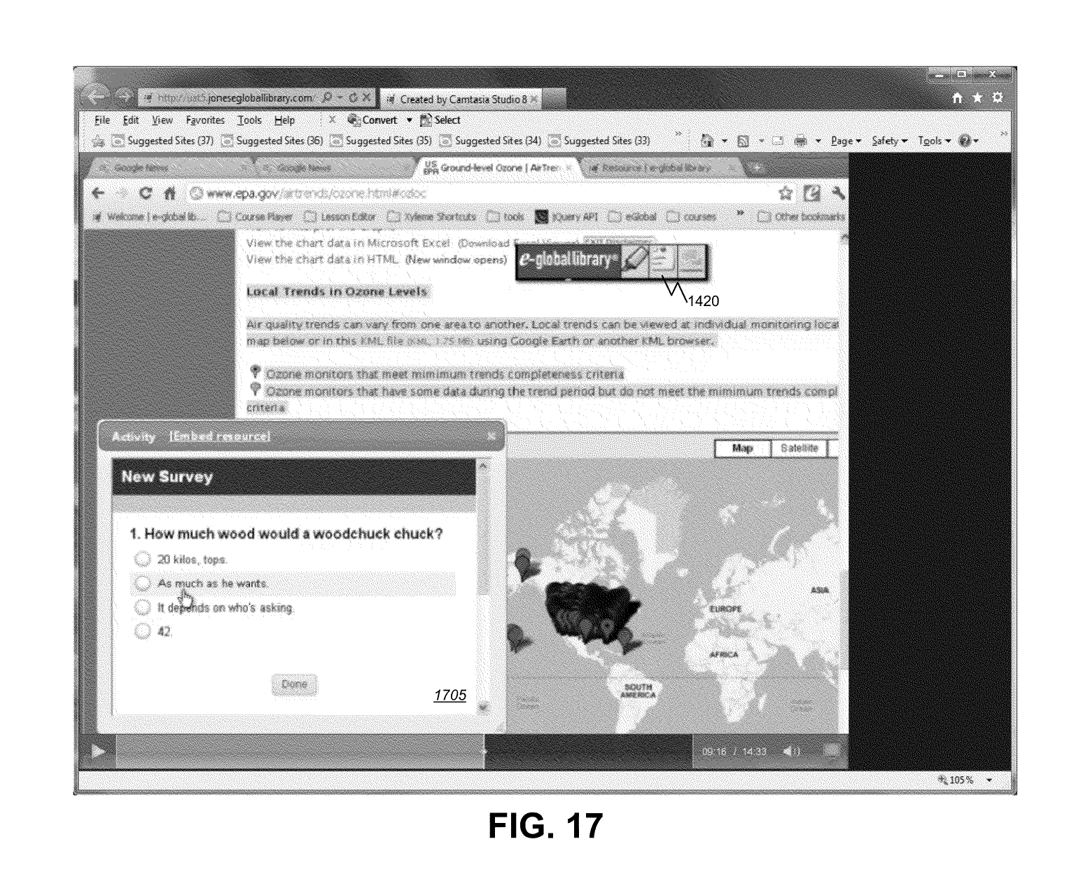

FIG. 17 is a screenshot of an exemplary user interface illustrating embedding of a poll or quiz in the content according to one embodiment. As noted above, the resources added to captured content using the note tool 1420 can include any of a variety of media and/or formats. In some cases, as illustrated here, this content can include a poll or quiz dialog 1705. The poll or quiz can be added to the note in any of a variety of different ways including but not limited to use of an editor that can be invoked through the note tool or elsewhere, by importing the quiz from a file or other resource, by cut and paste by the user, or by the content search and capture operations described above.

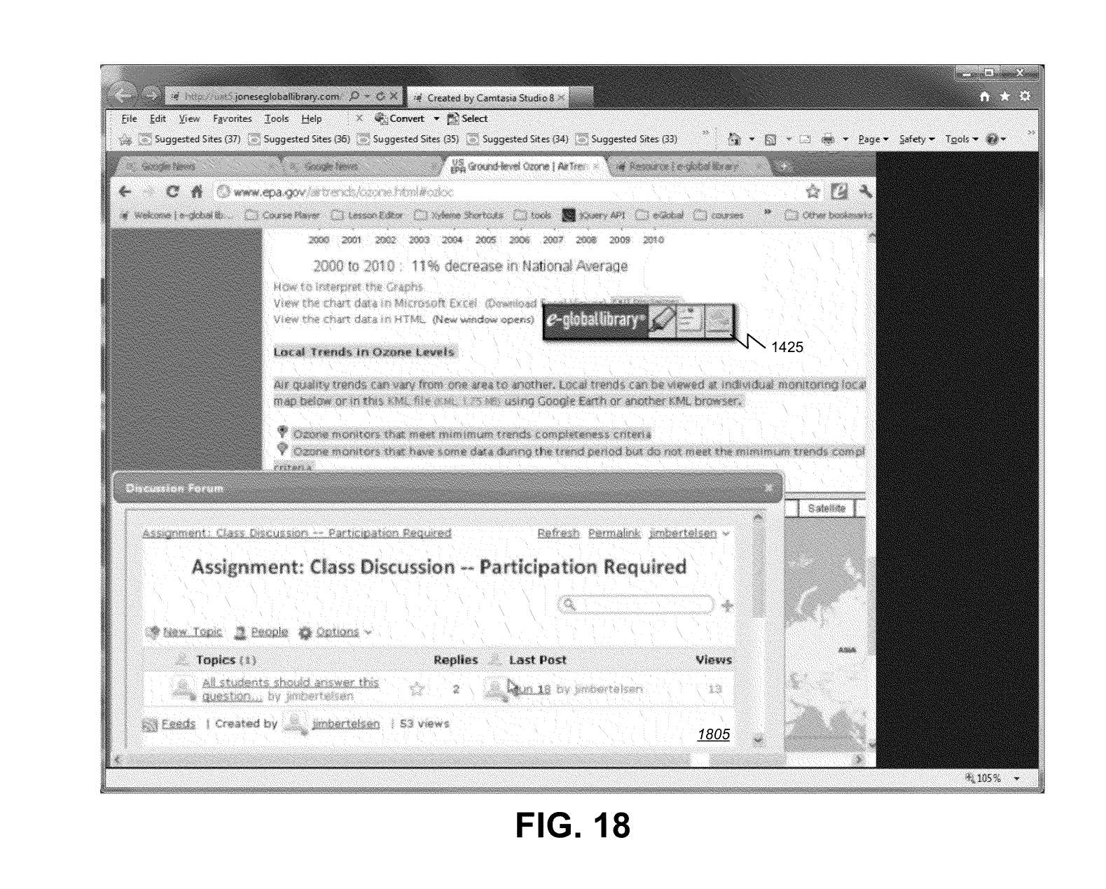

FIG. 18 is a screenshot of an exemplary user interface illustrating embedding of a discussion thread in the content according to one embodiment. As illustrated in this example, a user can select the content embedding tool 1425 from the editing toolbar. Once selected, this tool 1425 can then allow the user to add yet other types of content. For example, the embedding tool can allow the user to add a threaded discussion dialog 1805. The discussion may be maintained in a discussion forum elsewhere and linked to and/or imported into the threaded discussion dialog 1805 for access by the user of the captured content. Once again, this link can be created by cut and paste by the user, by the content search and capture operations described above, or by other means.

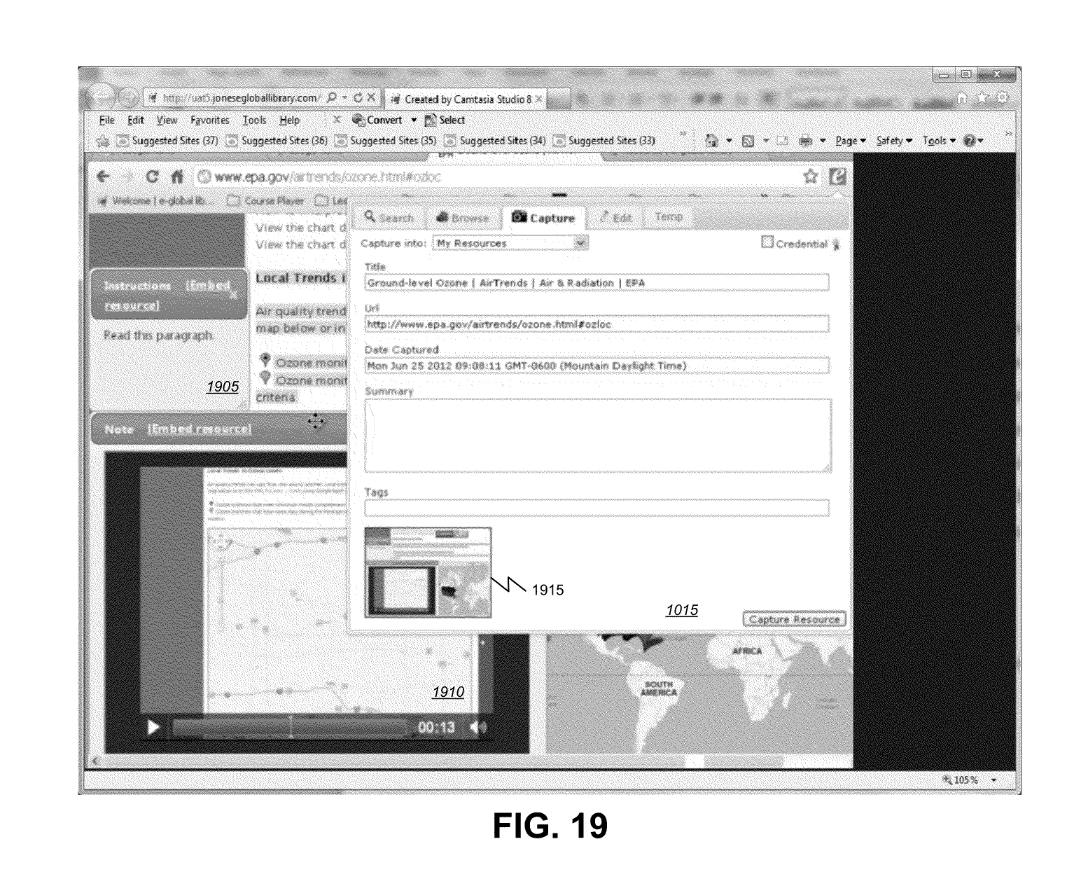

FIG. 19 is a screenshot of an exemplary user interface illustrating curating of edited content according to one embodiment of the present invention. As noted above, content that has been edited or added using any one or more of the tools described above can also be captured and stored in the library and made available to users. That is, regardless of what types of edits are made or additional content is added to the captured content, all content and edits can be saved though the content capture dialog 1015. This edited and captured content can be reflected, for example, in a thumbnail 1915 image of the content.

FIG. 20 is a flowchart illustrating a process for editing content of an online library according to one embodiment of the present invention. As illustrated in this example, editing the captured content through one or more functions of the content edit feature can comprise receiving 2005 through the graphical dialog of the tool an indication of a user selection a graphical element representing the content edit feature provided by the tool. In response to receiving 2005 this selection, a content edit toolbar comprising a plurality of graphical elements can be presented 2010. Each of the plurality of graphical elements of the content edit toolbar can represent a function of the content edit feature, e.g., a highlighter function, a note function, a content embedding function, etc. An indication of a user selection of one or more of the graphical elements representing the functions of the content edit feature can be received 2015 through the content edit toolbar and the corresponding content editing functions can be performed.

According to one embodiment and as described above, the functions of the content edit feature can comprise a highlighter function. In such cases, the highlighter function can be launched 2025 in response to receiving 2020 through the content edit toolbar an indication of a user selection of the graphical element of the content edit toolbar representing the highlighter function. Then, a user selection of at least a portion of a currently viewed content can be received 2030 and the portion of the currently viewed content selected by the user can be marked 2035 as highlighted.

Additionally or alternatively, the one or more functions of the content edit feature can comprise a note function as described above. In such cases, the note function can be launched 2045 in response to receiving 2040 through the content edit toolbar an indication of a user selection of the graphical element of the content edit toolbar representing the note function. Launching 2045 the note function can comprise presenting a graphical note element related to a currently viewed content. User defined text or other content directed to the currently viewed content can be received 2050 and the received user defined text or other content can be added 2055 to the graphical note element.

In yet another embodiment, the one or more functions of the content edit feature can additionally or alternatively comprise a content embedding function as also described above. In such cases, the content embedding function can be launched 2065 in response to receiving 2060 through the content edit toolbar an indication of a user selection of the graphical element of the content edit toolbar representing the content embedding function. Launching 2065 the content embedding function can comprise presenting a graphical dialog element related to a currently viewed content. A user selection of a resource, e.g., a threaded discussion or other content related to the currently viewed content, can be received 2070 and the user selected resource can be added 2075 to the graphical dialog element.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums or memory devices, such as CD-ROMs or other type of optical disks, floppy diskettes, ROMs, RAMs, EPROMs, EEPROMs, magnetic or optical cards, flash memory, or other types of machine-readable mediums or memory devices suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for locating and interacting content of an online library, the method comprising:
executing an application providing a view of content of the online library, wherein the application further provides access to a tool providing a plurality of functions supported by the online library for locating and interacting with the content of the online library;
receiving through the application an indication of a user request to access the tool;
in response to the indication, launching the tool through the application, wherein launching the tool comprises providing a graphical dialog including a first plurality of graphical elements representing each of a plurality of features provided by the tool, the plurality of features provided by the tool including at least a search feature and a browse feature; and
locating content through one or both of the search feature or the browse feature of the tool.

2. The method of claim 1, wherein the plurality of features provided by the tool further comprises a content capture feature and wherein the method further comprises capturing the located content through the content capture feature of the tool upon a selection of the content capture feature.

3. The method of claim 2, wherein the plurality of features provided by the tool further comprises a content edit feature and wherein the method further comprises editing the captured content through one or more functions of the content edit feature upon a selection of the content edit feature.

4. The method of claim 1, wherein locating content through the search feature comprises:
receiving through the graphical dialog an indication of a user selection of one of the first plurality of graphical elements representing the search feature provided by the tool; and
in response to the indication, updating the graphical dialog to further include a second plurality of graphical elements representing each of a plurality of search functions provided by the tool.

5. The method of claim 4, wherein the plurality of search functions includes a current searches function providing access to one or more searches and corresponding results.

6. The method of claim 5, wherein providing access to one or more searches and corresponding results comprises:
receiving through the graphical dialog an indication of a user selection of the graphical indication of the current searches function; and
in response to the indication, updating the graphical dialog to further include a third plurality of graphical elements representing each of one or more current searches, each of the third plurality of graphical elements including an identification of the represented current search.

7. The method of claim 6, further comprising:
receiving through the graphical dialog an indication of a user selection of one of the third plurality of graphical elements; and
in response to the indication, updating the graphical dialog to further include results for the search corresponding to the selected one of the third plurality of graphical elements.

8. The method of claim 7, wherein the selected one of the third plurality of graphical elements includes a graphical indication of a filter function of the tool and wherein the method further comprises:
receiving through the graphical dialog an indication of a user selection of the graphical indication of the filter function;
in response to the indication, updating the graphical dialog to further include one or more elements for defining filter conditions;
receiving filter conditions through the one or more elements for defining the filter conditions; and
based on the received filter conditions, updating the results for the search corresponding to the selected one of the third plurality of graphical elements.

9. The method of claim 4, wherein the plurality of search functions includes a favorite searches function providing access to one or more prior searches saved by the tool in response to a request from the user.

10. The method of claim 9, further comprising:
receiving through the graphical dialog an indication of a user selection of one of the second plurality of graphical elements representing the favorite searches function; and
in response to the indication, updating the graphical dialog to further include a list including a list identifying and providing access to each of the one or more prior searches.

11. The method of claim 4, wherein the plurality of search functions includes a search history function providing access to one or more prior searches saved by the tool automatically.

12. The method of claim 11, further comprising:
receiving through the graphical dialog an indication of a user selection of one of the second plurality of graphical elements representing the search history function; and
in response to the indication, updating the graphical dialog to further include a list including a list identifying and providing access to each of the one or more prior searches.

13. The method of claim 1, wherein locating content through the browse feature comprises:
receiving through the graphical dialog an indication of a user selection of one of the first plurality of graphical elements representing the browse feature provided by the tool; and
in response to the indication, updating the graphical dialog to a list including a list identifying and providing access to the content of the online library.

14. The method of claim 2, wherein capturing the located content through the content capture feature of the tool comprises:
receiving through the graphical dialog an indication of a user selection of one of the first plurality of graphical elements representing the content capture feature provided by the tool;
capturing currently viewed content automatically and in response to receiving the user selection;
launching a content capture dialog, the content capture dialog comprising a plurality of graphical elements representing information from the captured currently viewed content; and
presenting the content capture dialog including the plurality of graphical elements representing information from the captured currently viewed content within the graphical dialog.

15. The method of claim 14, further comprising:
receiving through the content capture dialog an indication of a user selection of a location for saving the captured currently viewed content; and
saving the captured currently viewed content at the location indicated by the user selection.

16. The method of claim 3, wherein editing the captured content through one or more functions of the content edit feature comprises:
receiving through the graphical dialog an indication of a user selection of one of the first plurality of graphical elements representing the content edit feature provided by the tool;
presenting a content edit toolbar comprising a plurality of graphical elements, each of the plurality of graphical elements representing a function of the content edit feature; and
receiving through the content edit toolbar an indication of a user selection of one or more of the graphical elements representing the functions of the content edit feature.

17. The method of claim 16, wherein the one or more functions of the content edit feature comprise a highlighter function and wherein the method further comprises:
launching the highlighter function in response to receiving through the content edit toolbar an indication of a user selection of the graphical element of the content edit toolbar representing the highlighter function;
receiving a user selection of at least a portion of a currently viewed content; and
marking the portion of the currently viewed content selected by the user as highlighted.

18. The method of claim 16, wherein the one or more functions of the content edit feature comprise a note function and wherein the method further comprises:
launching the note function in response to receiving through the content edit toolbar an indication of a user selection of the graphical element of the content edit toolbar representing the note function, wherein launching the note function comprises presenting a graphical note element related to a currently viewed content;
receiving user defined text or other content directed to the currently viewed content; and
adding the received user defined text or other content to the graphical note element.

19. The method of claim 16, wherein the one or more functions of the content edit feature comprise a content embedding function and wherein the method further comprises:
launching the content embedding function in response to receiving through the content edit toolbar an indication of a user selection of the graphical element of the content edit toolbar representing the content embedding function, wherein launching the content embedding function comprises presenting a graphical dialog element related to a currently viewed content;
receiving a user selection of a resource related to the currently viewed content; and
adding the user selected resource to the graphical dialog element.

20. A system comprising:
a processor; and
a memory coupled with and readable by the processor and storing therein a set of instructions which, when executed by the processor, causes the processor to provide for locating and interacting content of an online library by:
executing an application providing a view of content of the online library, wherein the application further provides access to a tool providing a plurality of functions supported by the online library for locating and interacting with the content of the online library,
receiving through the application an indication of a user request to access the tool,
in response to the indication, launching the tool through the application, wherein launching the tool comprises providing a graphical dialog including a first plurality of graphical elements representing each of a plurality of features provided by the tool, the plurality of features provided by the tool including at least a search feature, a browse feature, a content capture feature, and a content edit feature,
locating content through one or both of the search feature or the browse feature of the tool,
capturing the located content through the content capture feature of the tool upon a selection of the content capture feature, and
editing the captured content through one or more functions of the content edit feature upon a selection of the content edit feature.

21. A computer-readable memory comprising a set of instructions stored therein which, when executed by a processor, causes the processor to provide for locating and interacting content of an online library by:
executing an application providing a view of content of the online library, wherein the application further provides access to a tool providing a plurality of functions supported by the online library for locating and interacting with the content of the online library;
receiving through the application an indication of a user request to access the tool;
in response to the indication, launching the tool through the application, wherein launching the tool comprises providing a graphical dialog including a first plurality of graphical elements representing each of a plurality of features provided by the tool, the plurality of features provided by the tool including at least a search feature, a browse feature, a content capture feature, and a content edit feature;
locating content through one or both of the search feature or the browse feature of the tool;
capturing the located content through the content capture feature of the tool upon a selection of the content capture feature; and
editing the captured content through one or more functions of the content edit feature upon a selection of the content edit feature.
